(19) United States
(12) Patent Application Publication
(10) Pub. No.: US 2014/0191154 A1
(43) Pub. Date: Jul. 10, 2014

(54) COMPOSITIONS COMPRISING 1,1,1,2,2-PENTAFLUOROPROPANE AND A FLUOROOLEFIN AND USES THEREOF

(71) Applicants: Barbara Haviland Minor, Elkton, MD (US); William Joseph Simonsick, Boothwyn, PA (US); Konstantinos Kontomaris, Wilmington, DE (US)

(72) Inventors: Barbara Haviland Minor, Elkton, MD (US); William Joseph Simonsick, Boothwyn, PA (US); Konstantinos Kontomaris, Wilmington, DE (US)

(73) Assignee: E I DU PONT DE NEMOURS AND COMPANY, Wilmington, DE (US)

(21) Appl. No.: 14/240,043

(22) PCT Filed: Aug. 20, 2012
(86) PCT No.: PCT/US12/51635

§ 371 Date: Feb. 21, 2014

Related U.S. Application Data
(60) Provisional application No. 61/528,337, filed on Aug. 29, 2011.

(51) Int. Cl. C09K 5/04; C09K 3/30; F02G 1/04; C08J 9/04; F25B 31/00; B65B 3/04

(52) U.S. Cl. CPC C09K 5/045; F25B 31/00; B65B 3/04; F02G 1/04; C08J 9/04; C09K 3/30
USPC 252/68; 62/119; 165/104.21; 62/77; 62/498; 53/473; 60/531; 252/67; 516/12; 521/131; 516/8

(57) ABSTRACT

Compositions are disclosed comprising: (a) 1,1,1,2,2-pentafluoropropane; (b) a compound selected from the group consisting of 2,3,3,3-tetrafluoropropene, E-1,3,3,3-tetrafluoropropene, and 1,1,1-trifluoropropene; and optionally (c) a compound selected from the group consisting of 1,1,1,2-tetrafluoroethane and difluoromethane. Such compositions are useful in methods to produce cooling, produce heat, transfer heat, form a foam, produce aerosol products, for recovering heat, and for replacing existing refrigerants. Additionally, these compositions are useful in refrigeration, air conditioning and heat pump apparatus.

### FIELD OF THE INVENTION

The present disclosure relates to compositions for use in refrigeration, air-conditioning, and heat pump systems wherein the composition comprises 1,1,1,2,2-pentafluoropropane and a fluoroolefin. The compositions of the present invention are useful in processes for producing cooling or heat, as heat transfer fluids, foam blowing agents, aerosol propellants, fire suppression, fire extinguishing agents and power cycle working fluids.

### BACKGROUND OF THE INVENTION

The refrigeration industry has been working for the past few decades to find replacement refrigerants for the ozone depleting chlorofluorocarbons (CFCs) and hydrochlorofluorocarbons (HCFCs) being phased out as a result of the Montreal Protocol. The solution for most refrigerant producers has been the commercialization of hydrofluorocarbon (HFC) refrigerants. The new HFC refrigerants, HFC-134a being the most widely used at this time, have zero ozone depletion potential and thus are not affected by the current regulatory phase out as a result of the Montreal Protocol.

Further environmental regulations may ultimately cause global phase out of certain HFC refrigerants. Currently, the automobile industry is facing regulations relating to global warming potential for refrigerants used in mobile air-conditioning. Therefore, there is a great current need to identify new refrigerants with reduced global warming potential for the mobile air-conditioning market. Should the regulations be more broadly applied in the future, for instance for stationary air conditioning and refrigeration systems, an even greater need will be felt for refrigerants that can be used in all areas of the refrigeration and air-conditioning industry.

Currently proposed replacement refrigerants for HFC-134a include HFC-152a, pure hydrocarbons such as butane or propane, or “natural” refrigerants such as CO₂. Many suggested replacements are toxic, flammable, and/or have low energy efficiency. Therefore, new alternative refrigerants are being sought. Replacements for other HFC and HCFC containing refrigerants are also being proposed, such as replacements for HCFC-22, R404A, R407C, R410A among others.

### SUMMARY OF THE INVENTION

In accordance with the present invention a composition is provided that comprises (a) 1,1,1,2,2-pentafluoropropane; (b) a compound selected from the group consisting of 2,3,3,3-tetrafluoropropene, E-1,3,3,3-tetrafluoropropene, and 1,1,1-trifluoropropene; and optionally (c) a compound selected from the group consisting of 1,1,1,2-tetrafluoroethane and difluoromethane.

Also a process to produce cooling is disclosed. The process comprises condensing a composition of the present invention and is thereafter evaporating said composition in the vicinity of a body to be cooled.

Also a process to produce heat is disclosed. The process comprises condensing the composition of the present invention in the vicinity of a body to be heated and thereafter evaporating said composition.

Also a method of forming a foam is disclosed. The method comprises (a) adding to a foamable composition a composition of the present invention; and (b) reacting the foamable composition under conditions effective to form a foam.

Also a process for producing aerosol products is disclosed. The process comprises the step of adding the composition of the present invention to active ingredients in an aerosol container, wherein said composition functions as a propellant.

Also a process for recovering heat is disclosed. The process comprises evaporating a liquid phase working fluid comprising a composition of the present invention in a heat exchanger in contact with a system that provides heat thus producing a vapor phase working fluid and passing said vapor phase working fluid to an expander wherein mechanical energy is produced.

Also a refrigeration, air conditioning or heat pump apparatus is provided. The apparatus comprises a compressor, a condenser, an expansion device and an evaporator and containing the composition of the present invention.

### DETAILED DESCRIPTION

Before addressing details of embodiments described below, some terms are defined or clarified.

### DEFINITIONS

As used herein, the term heat transfer composition means a composition used to carry heat from a heat source to a heat sink.

A heat source is defined as any space, location, object or body from which it is desirable to add, transfer, move or remove heat. Examples of heat sources is spaces (open or enclosed) requiring refrigeration or cooling, such as refrigerator or freezer cases in a supermarket, building spaces requiring air-conditioning, industrial water chillers or the passenger compartment of an automobile requiring air-conditioning. In some embodiments, the heat transfer composition may remain in a constant state throughout the transfer process (i.e., not evaporate or condense). In other embodiments, evaporative cooling processes may utilize heat transfer compositions as well.

A heat sink is defined as any space, location, object or body capable of absorbing heat. A vapor compression refrigeration system is one example of such a heat sink.

A heat transfer system is the system (or apparatus) used to produce a heating or cooling effect in a particular space. A heat transfer system may be a mobile system or a stationary system.

Examples of heat transfer systems included but are not limited to air conditioners, freezers, refrigerators, heat pumps, water chillers, flooded evaporator chillers, direct expansion chillers, walk-in coolers, supermarket systems, heat pumps, mobile refrigerators, mobile air conditioning units and combinations thereof.

As used herein, mobile heat transfer system refers to any refrigeration, air conditioner, or heating apparatus incorporated into a transportation unit for the road, rail, sea or air. In addition, mobile refrigeration or air conditioner units, include those apparatus that are independent of any moving carrier and are known as “intermodal” systems. Such intermodal systems include “container’ (combined sea/land transport) as well as “swap bodies” (combined road/rail transport).

As used herein, stationary heat transfer systems are systems that are fixed in place during operation. A stationary heat transfer system may be associated within or attached to buildings of any variety or may be stand alone devices located out of doors, such as a soft drink vending machine. These stationary applications may be stationary air conditioning and heat pumps (including but not limited to chillers, high temperature heat pumps, residential, commercial or industrial air conditioning systems, and including window, ductless, ducted, packaged terminal, chillers, and those exterior but connected to the building such as rooftop systems). In stationary refrigeration applications, the disclosed compositions may be useful in equipment including commercial, industrial or residential refrigerators and freezers, ice machines, self-contained coolers and freezers, flooded evaporator chillers, direct expansion chillers, walk-in and reach-in coolers and freezers, and combination systems. In some embodiments, the disclosed compositions may be used in supermarket refrigeration systems. Additionally, stationary systems include secondary loop systems that utilize a primary refrigerant and a secondary heat transfer fluid.

Refrigeration capacity (also referred to as cooling capacity) is a term to define the change in enthalpy of a refrigerant in an evaporator per pound of refrigerant circulated, or the heat removed by the refrigerant in the evaporator per unit volume of refrigerant vapor exiting the evaporator (volumetric capacity). The refrigeration capacity is a measure of the ability of a refrigerant or heat transfer composition to produce cooling. Therefore, the higher the capacity, the greater the cooling that is produced. Cooling rate refers to the heat removed by the refrigerant in the evaporator per unit time.

Coefficient of performance (COP) is the amount of heat removed divided by the required energy input to operate the cycle. The higher the COP, the higher is the energy efficiency. COP is directly related to the energy efficiency ratio (EER) that is the efficiency rating for refrigeration or air conditioning equipment at a specific set of internal and external temperatures.

The term “subcooling” is meant the reduction of the temperature of a liquid below that liquid's saturation point for a given pressure. The saturation point is the temperature at which a vapor composition is is completely condensed to a liquid (also referred to as the bubble point). But subcooling continues to cool the liquid to a lower temperature liquid at the given pressure. By cooling a liquid below the saturation temperature, the net refrigeration capacity can be increased. Subcooling thereby improves refrigeration capacity and energy efficiency of a system. Subcool amount is the amount of cooling below the saturation temperature (in degrees) or how far below its saturation temperature a liquid composition is cooled.

Superheat is a term that defines how far above its saturation vapor temperature (the temperature at which, if the composition is cooled, the first drop of liquid is formed, also referred to as the “dew point”) a vapor composition is heated.

Temperature glide (sometimes referred to simply as “glide”) is the absolute value of the difference between the starting and ending temperatures of a phase-change process by a refrigerant within a component of a refrigerant system, exclusive of any subcooling or superheating. This term may be used to describe condensation or evaporation of a near azeotrope or non-azeotropic composition.

By azeotropic composition is meant a constant-boiling mixture of two or more substances that behave as a single substance. One way to characterize an azeotropic composition is that the vapor produced by partial evaporation or distillation of the liquid has the same composition as the liquid from which it is evaporated or distilled, i.e., the mixture distills/refluxes without compositional change. Constant-boiling compositions are characterized as azeotropic because they exhibit either a maximum or minimum boiling point, as compared with that of the non-azeotropic mixture of the same compounds. An azeotropic composition will not fractionate within a refrigeration or air conditioning system during operation, which may reduce heat transfer and efficiency of the system. Additionally, an azeotropic composition will not fractionate upon leakage from a refrigeration or air conditioning system.

An azeotrope-like composition (also commonly referred to as a “near-azeotropic composition”) is a substantially constant boiling liquid admixture of two or more substances that behaves essentially as a single substance. One way to characterize a azeotrope-like composition is that the vapor produced by partial evaporation or distillation of the liquid has substantially the same composition as the liquid from which it was evaporated or distilled, that is, the admixture distills/refluxes without substantial composition change. Another way to characterize a azeotrope-like composition is that the bubble point vapor pressure and the dew point vapor pressure of the composition at a particular temperature are substantially the same. Herein, a composition is azeotrope-like if, after 50 wt % of the composition is removed, such as by evaporation or boiling off, the difference in vapor pressure between the original composition and the composition remaining after 50 wt % of the original composition has been removed is less than about 10 percent.

A non-azeotropic composition is a mixture of two or more substances that behaves as a simple mixture rather than a single substance. One way to characterize a non-azeotropic composition is that the vapor produced by partial evaporation or distillation of the liquid has a substantially different composition as the liquid from which it was evaporated or distilled, that is, the admixture distills/refluxes with substantial composition change. Another way to characterize a non-azeotropic composition is that the bubble point vapor pressure and the dew point vapor pressure of the composition at a particular temperature are substantially different. Herein, a composition is non-azeotropic if, after 50 wt % of the composition is removed, such as by evaporation or boiling off, the difference in vapor pressure between the original composition and the composition remaining after 50 wt % of the original composition has been removed is greater than about 10 percent.

As used herein, the term “lubricant” means any material added to a composition or a compressor (and in contact with any heat transfer composition in use within any heat transfer system) that provides lubrication to the compressor to aid in preventing parts from seizing.

As used herein, compatibilizers are compounds which improve solubility of the hydrofluorocarbon of the disclosed compositions in heat transfer system lubricants. In some embodiments, the compatibilizers improve oil return to the compressor. In some embodiments, the composition is used with a system lubricant to reduce oil-rich phase viscosity.

As used herein, oil-return refers to the ability of a heat transfer composition to carry lubricant through a heat transfer system and return it to the compressor. That is, in use, it is not uncommon for some portion of the compressor lubricant to be carried away by the heat transfer composition from the compressor into the other portions of the system. In such systems, if the lubricant is not efficiently returned to the compressor, the compressor will eventually fail due to lack of lubrication.

As used herein, “ultra-violet” dye is defined as a UV fluorescent or phosphorescent composition that absorbs light in the ultra-violet or “near” ultra-violet region of the electromagnetic spectrum. The fluorescence produced by the UV fluorescent dye under illumination by a UV light that emits at least some radiation with a wavelength in the range of from 10 nanometers to about 775 nanometers may be detected.

Global warming potential (GWP) is an index for estimating relative global warming contribution due to atmospheric emission of a kilogram of a particular greenhouse gas compared to emission of a kilogram of carbon dioxide. GWP can be calculated for different time horizons showing the effect of atmospheric lifetime for a given gas. The GWP for the 100 year time horizon is commonly the value referenced. For mixtures, a weighted average can be calculated based on the individual GWPs for each component.

Ozone depletion potential (ODP) is a number that refers to the amount of ozone depletion caused by a substance. The ODP is the ratio of the impact on ozone of a chemical compared to the impact of a similar mass of CFC-11 (fluorotrichloromethane). Thus, the ODP of CFC-11 is defined to be 1.0. Other CFCs and HCFCs have ODPs that range from 0.01 to 1.0. HFCs have zero ODP because they do not contain chlorine.

As used herein, the terms “comprises,” “comprising,” “includes,” “including,” “has,” “having” or any other variation thereof, are intended to cover a non-exclusive inclusion. For example, a composition, process, method, article, or apparatus that comprises a list of elements is not necessarily limited to only those elements but may include other elements not expressly listed or inherent to such composition, process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The transitional phrase “consisting of” excludes any element, step, or ingredient not specified. If in the claim such would close the claim to the inclusion of materials other than those recited except for impurities ordinarily associated therewith. When the phrase “consists of” appears in a clause of the body of a claim, rather than immediately following the preamble, it limits only the element set forth in that clause; other elements are not excluded from the claim as a whole.

The transitional phrase “consisting essentially of” is used to define a composition, method or apparatus that includes materials, steps, features, components, or elements, in addition to those literally disclosed provided that these additional included materials, steps, features, components, or elements do materially affect the basic and novel characteristic(s) of the claimed invention. The term ‘consisting essentially of’ occupies a middle ground between “comprising” and ‘consisting of’.

Where applicants have defined an invention or a portion thereof with an open-ended term such as “comprising,” it should be readily understood that (unless otherwise stated) the description should be interpreted to also describe such an invention using the terms “consisting essentially of” or “consisting of.”

Also, use of “a” or “an” are employed to describe elements and components described herein. This is done merely for convenience and to is give a general sense of the scope of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. Although methods and materials similar or equivalent to those described herein can be used in the practice or testing of embodiments of the disclosed compositions, suitable methods and materials are described below. All publications, patent applications, patents, and other references mentioned herein are incorporated by reference in their entirety, unless a particular passage is cited. In case of conflict, the present specification, including definitions, will control. In addition, the materials, methods, and examples are illustrative only and not intended to be limiting.

### Compositions

In one embodiment, the compositions disclosed herein comprise (a) 1,1,1,2,2-pentafluoropropane; (b) a compound selected from the group consisting of 2,3,3,3-tetrafluoropropene, E-1,3,3,3-tetrafluoropropene, and 1,1,1-trifluoropropene; and optionally (c) a compound selected from the group consisting of 1,1,1,2-tetrafluoroethane and difluoromethane.

In another embodiment the compositions disclosed herein consist essentially of (a) 1,1,1,2,2-pentafluoropropane; (b) a compound selected from the group consisting of 2,3,3,3-tetrafluoropropene, E-1,3,3,3-tetrafluoropropene, and 1,1,1-trifluoropropene; and optionally (c) a compound selected from the group consisting of 1,1,1,2-tetrafluoroethane and difluoromethane.

In another embodiment, the compositions disclosed herein consist of (a) 1,1,1,2,2-pentafluoropropane; (b) a compound selected from the group consisting of 2,3,3,3-tetrafluoropropene, E-1,3,3,3-tetrafluoropropene, and 1,1,1-trifluoropropene; and optionally (c) a compound selected from the group consisting of 1,1,1,2-tetrafluoroethane and difluoromethane.

1,1,1,2,2-Pentafluoropropane (also known as HFC-245cb or CF₃CH₂CHF₂) 2,3,3,3-tetrafluoropropene (also known as HFO-1234yf or CF₃CF═CH₂), E-1,3,3,3-tetrafluoropropene (also known as trans-1,3,3,3-tetrafluoropropene, E-HFO-1234ze, trans-HFO-1234ze or CF₃CH═CHF), and 1,1,1-trifluoropropene (also known as HFO-1243zf, TFP or CF₃CH═CH₂), are available commercially or may be prepared by methods known in the art of fluorocarbon compound manufacture.

1,1,1,2-tetrafluoroethane (CF₃CH₂F), also known as HFC-134a or R-134a and difluoromethane (CH₂F₂), also known as HFC-32 or R-32 are both available commercially or can be made by methods known in the art of fluorocarbon compound manufacture.

In another embodiment, the compositions may comprise azeotropic or azeotrope-like combinations of (a) and (b) or (a), (b), and (c). Table 1 provides a list of azeotrope-like combinations.

TABLE 1

| | Azeotrope-like | Alternative | Alternative |
|---|---|---|---|
| Components | ranges (wt %) | range A (wt %) | range B (wt %) |
| HFO-1234yf/HFC-245cb | 1-99.9/0.1-99 | 20-95/80-5 | 40-90/10-60 |
| trans-HFC-1234ze/HFC-245cb | 1-99.9/0.1-99 | 20-95/80-5 | 40-90/10-60 |
| HFC-1243zf/HFC-245cb | 1-99.9/0.1-99 | 20-95/80-5 | 40-90/10-60 |
| HFO-1234yf/HFC-245cb/HFC- | 1-98.9/0.1-98/1-98 | 20-90/5-40/5-50 | 40-90/5-50/5-50 |
| 134a | | | |
| trans-HFO-1234ze/HFC- | 1-98.9/0.1-98/1-98 | 20-90/5-40/5-50 | 40-90/5-50/5-50 |
| 245cb/HFC-134a | | | |
| HFO-1243zf/HFC-245cb/HFC- | 1-98.9/0.1-98/1-98 | 20-90/5-40/5-50 | 40-90/5-50/5-50 |
| 134a | | | |
| HFO-1234yf/HFC-245cb/HFC-32 | 1-49/1-30/50-99 | 5-30/5-30/50-90 | 5-35/5-20/60-90 |
| trans-HFO-1234ze/HFC- | 1-40/1-30/58-98 | 5-20/5-30/60-90 | 5-35/5-20/60-90 |
| 245cb/HFC-32 | | | |
| HFO-1243zf/HFC-245cb/HFC-32 | 1-36/1-36/46-98 | 5-30/5-30/50-90 | 5-30/5-20/50-90 |

In another embodiment, the compositions comprise from about 0.1 wt % to about 99 wt % 1,1,1,2,2-pentafluoropropane and from about 1.0 wt % to about 99.9 wt % of a compound selected from the group consisting of 2,3,3,3-tetrafluoropropene, E-1,3,3,3-tetrafluoropropene and 1,1,1-trifluoropropene.

In another embodiment the compositions comprise from about 0.1 wt % to about 98 wt % 1,1,1,2,2-pentafluoropropane; from about 1.0 wt % to about 98.9 wt % of a compound selected from the group consisting of 2,3,3,3-tetrafluoropropene, E-1,3,3,3-tetrafluoropropene and 1,1,1-trifluoropropene; and from about 1.0 wt % to about 98 wt % 1,1,1,2-tetrafluoroethane.

In another embodiment the compositions comprise from about 0.1 wt % to about 30 wt % 1,1,1,2,2-pentafluoropropane, from about 1.0 wt % to about 49 wt % 2,3,3,3-tetrafluoropropene, and from about 50 wt % to about 98 wt % difluoromethane.

In another embodiment the compositions comprise from about 0.1 wt % to about 30 wt % 1,1,1,2,2-pentafluoropropane, from about 1.0 wt % to about 40 wt % E-1,3,3,3-tetrafluoropropene, and from about 58 wt % to about 98 wt % difluoromethane.

In another embodiment, the compositions comprise from about 1.0 wt % to about 36 wt % 1,1,1,2,2-pentafluoropropane, from about 1.0 wt % to about 36 wt % 1,1,1-trifluoropropene, and from about 46 wt % to about 98 wt % difluoromethane.

In another embodiment, the compositions may comprise azeotropic combinations. Table 2 lists the azeotropic combinations of the present invention.

TABLE 2

| | | | | Pressure at |
|---|---|---|---|---|
| | | | | 25° C., psia |
| Component A | Component B | Wt % A | Wt % B | (kPa) |
| trans-HFO-1234ze | HFC-245cb | 55.8 | 44.2 | 88.2 (608) |
| HFO-1243zf | HFC-245cb | 54.0 | 46.0 | 88.4 (609) |

In another embodiment the compositions comprise an azeotropic combination of about 44.2 wt % 1,1,1,2,2-pentafluoropropane and about 55.8 wt % 1,3,3,3-tetrafluoropropene which has a pressure of about 88.2 psia (608 kPa) at 25° C. and about 88.2 psia (608 kPa); or about 46.0 wt % 1,1,1,2,2-pentafluoropropane and about 54.0 wt % 3,3,3-trifluoropropene which has a pressure of about 88.4 psia (609 kPa) at 25.

In some embodiments, the present compositions may comprise optional other components.

In some embodiments, the optional other components (also referred to herein as additives) in the compositions disclosed herein may comprise one or more components selected from the group consisting of lubricants, dyes, solubilizing agents, compatibilizers, stabilizers, tracers, perfluoropolyethers, anti wear agents, extreme pressure agents, corrosion and oxidation inhibitors, metal surface energy reducers, metal surface deactivators, free radical scavengers, foam control agents, viscosity index improvers, pour point depressants, detergents, viscosity adjusters, and mixtures thereof. Indeed, many of these optional other components fit into one or more of these categories and may have qualities that lend themselves to achieve one or more performance characteristic.

Of note are additives selected from the group consisting of acetates, borates, carbonates, bicarbonates, phosphates, nitrates, hydroxides, oxides, molybdates, bromides, bromates, chlorates, chlorides, or iodides, phosphate esters, organic phosphonates, and phosphonium salts, boric acid, organic boron compounds, brominated compounds, chlorinated paraffins, ammonium polyphosphates, melamines, mixtures of water with polyalkylene glycols or polyol esters, perfluorinated lubricants, fluoroketones, fluoroiodo compounds, or mixtures thereof.

In some embodiments, one or more additive is present in the compositions disclosed in small amounts relative to the overall composition. In some embodiments, the amount of additive(s) concentration in the disclosed compositions is from less than about 0.1 wt % to as much as about 5 wt % of total additive. In some embodiments, the additives are present in the disclosed compositions in is an amount between about 0.1 wt % to about 3.5 wt %. In other embodiments, the amount of additive is from about 0.1 to less than 1 wt %. The additive component(s) for the disclosed composition is selected on the basis of the utility and/or individual equipment components or the system requirements.

In some embodiments, the disclosed compositions include at least one lubricant selected from the group consisting of mineral oils (oils of mineral origin), synthetic lubricants, and mixtures thereof.

In some embodiments, the disclosed compositions include at least one lubricant selected from those suitable for use with refrigeration or air-conditioning equipment. In some embodiments, the disclosed compositions include at least one synthetic oil selected from those readily known in the field of compression refrigeration lubrication.

In some embodiments, at least one optional component is a mineral oil lubricant. In some embodiments, the mineral oil lubricant is selected from the group consisting of paraffins (including straight chain saturated hydrocarbons, branched chain saturated hydrocarbons, and mixtures thereof), naphthenes (including saturated cyclic and ring structures), aromatics (those with unsaturated hydrocarbons containing one or more ring, wherein one or more ring is characterized by alternating carbon-carbon double bonds) and non-hydrocarbons (those molecules containing atoms such as silicon, sulfur, nitrogen, oxygen and mixtures thereof), and mixtures and combinations of thereof.

Some embodiments may contain one or more synthetic lubricant. In some embodiments, the synthetic lubricant is selected from the group consisting of alkyl substituted aromatics (such as benzene or naphthalene substituted with linear, branched, or mixtures of linear and branched alkyl groups, often generically referred to as alkylbenzenes), synthetic paraffins and naphthenes, poly (alpha olefins), polyglycols (including polyalkyene glycols), dibasic acid esters, polyesters, neopentyl esters, polyvinyl ethers (PVEs), silicones, silicate esters, fluorinated compounds, phosphate esters and mixtures and combinations thereof.

In some embodiments, the compositions as disclosed herein further comprise at least one lubricant selected from the group consisting of mineral oils, alkylbenzenes, polyalphaolefins, polyalkylene glycols, polyol esters, polyvinyl ethers, and mixtures thereof.

In some embodiments, the compositions disclosed herein contain at least one commercially available lubricant. In some embodiments the compositions disclosed herein contain at least one lubricant selected from the group consisting of BVM 100 N (paraffinic mineral oil sold by BVA Oils), Suniso® 1 GS, Suniso® 3GS and Suniso® 5GS (naphthenic mineral oils sold by Crompton Co.), Sontex® 372LT (naphthenic mineral oil sold by Pennzoil), Calumet® RO-30 (naphthenic mineral oil sold by Calumet Lubricants), Zerol® 75, Zerol® 150 and Zerol® 500 (linear alkylbenzenes sold by Shrieve Chemicals) and HAB 22 (branched alkylbenzene sold by Nippon Oil), polyol esters (POEs) such as Castrol® 100 (Castrol, United Kingdom), polyalkylene glycols (PAGs) such as RL-488A from Dow (Dow Chemical, Midland, Mich.), and mixtures thereof.

Of particular note for use in the present invention are lubricants selected from the group consisting of polyalkylene glycol, polyol ester and polyvinylether lubricants.

In some embodiments, the lubricant is present in an amount of less than 5.0 wt % to the total composition. In other embodiments, the amount of lubricant is between about 0.1 and 3.5 wt % of the total composition. In another embodiment, the amount of lubricant is less than 1 wt % of the total composition.

In some embodiments, the disclosed compositions may include additives to reduce the flammability characteristics of the composition.

Hydrocarbon refrigerants and some hydrofluorocarbon refrigerants (such as HFC-32) and fluoroolefins (such as HFO-1243zf) are known to be flammable compounds and in some applications, the reduction of the flammability characteristics is desired. Additives that may be included in the disclosed compositions include, salts (e.g. acetates, borates, carbonates, bicarbonates, phosphates, nitrates, hydroxides, oxides, molybdates, bromides, bromates, chlorates, chlorides, or iodides), phosphorous compounds including phosphate esters, organic phosphonates, and phosphonium salts, boric acid, organic boron compounds, brominated compounds, chlorinated paraffins, ammonium polyphosphates, melamines, mixtures of water with polyalkylene glycols or polyol esters, perfluorinated lubricants, fluoroketones, fluoroiodo compounds, or mixtures thereof.

Representative salts for reducing flammability include but are not limited to: sodium acetate (CH₃CO₂Na), potassium acetate (CH₃CO₂K), potassium carbonate (K₂CO₃), iron (II) carbonate (FeCO₃), sodium carbonate (Na₂CO₃), ammonium carbonate ((NH₄)₂CO₃), sodium bicarbonate (NaHCO₃), potassium bicarbonate, (KHCO₃), ammonium phosphate ((NH₄)₃PO₄), potassium nitrate (KNO₃), sodium chloride (NaCl), potassium chloride (KCl), cobalt chloride (CoCl₂), rubidium chloride (RbCl), titanium chloride (TiCl₄), sodium bromide (NaBr), potassium bromide (KBr), rubidium bromide (RbBr), potassium iodide (KI), rubidium iodide (RbI), magnesium hydroxide (Mg(OH)₂), aluminum hydroxide (Al(OH)₃), zinc borate (3ZnO:2B₂O₃), zinc oxide (ZnO), zinc molybdate (ZnMoO₄), calcium molybdate (CaMoO₄), copper oxides, (Cu₂O and CuO), and antimony oxides, including but not limited to antimony trioxide (Sb₂O₃) and antimony pentoxide (Sb₂O₅), and others. Such salts are available from many chemical suppliers such as Aldrich, Milwaukee, Wis.

In some embodiments, the compositions as disclosed herein may further comprise phosphorus compounds for reducing flammability including but not limited to phosphate esters, including but not limited to: trialkyl phosphates, triaryl phosphates, mixed alkyl-aryl phosphates (alkyldiaryl, dialkylaryl or alkylated aryl), and cyclic phosphates. Representative trialkyl phosphates include: trimethyl phosphate ((CH₃)₃PO₄); triethyl phosphate ((CH₃CH₂)₃PO₄); tributyl phosphate ((C₄H₉)₃PO₄); trioctyl phosphate ((C₈H₁₇)₃PO₄); and tri(2-ethylhexyl)phosphate ((CH₃CH(C₂H₅)(CH₂)₄)₃PO₄). Representative triaryl phosphates include: triphenyl phosphate ((C₆H₅O)₃PQ); tricresyl phosphate (TCP, (CH₃C₆H₄O)₃PO); and trixylenyl phosphate (((CH₃)₂C₆H₃O)₃PO). Representative mixed alkyl-aryl phosphates include: isopropylphenyl phenyl phosphate (IPPP, (C₆H₅O)₂((CH₃)₂CHO)PO) and bis(t-butylphenyl) phenyl phosphate (TBPP, (C₆H₅O)₂((CH₃)₃C)PO). Such phosphorus compounds are available from multiple chemical suppliers such as Aldrich (Milwaukee, Wis.); Alfa Aesar (Ward Hill, Mass.); or Akzo Nobel (Arnhem, the Netherlands). Additional representative phosphorus compounds are Syn-O-Ad® 8784, a butylated triphenyl phosphate from Akzo Nobel (Arnhem, the Netherlands); Durad® 620, a tert-butylated triphenyl phosphate from Great Lakes Chemical Corporation (GLCC, West Lafayette, Ind.); and Durad® 220 and 110, iso-propylated triphenyl phosphates also from GLCC.

In some embodiments, the disclosed compositions may further organic phosphonates and phosphonium salts for reducing flammability including but not limited to: tris monochloropropyl phosphate (TMCPP, different isomers, tris(2-chloroisopropyl) phosphate, and tris(2-chloropropyl) phosphate); tris (1,3-dichloro-2-propyl) phosphate (TDCPP, P(OCH₂OH)₄Cl); dimethyl phosphonate (PHO(OCH₃)₂); and tetrakis(hydroxymethyl)phosphonium chloride (P(CH₂OH)₄Cl) among others. These phosphorus compounds are also available from Aldrich, Alfa Aesar, or Akzo Nobel.

In some embodiments, the disclosed compositions may further comprise boron compounds such as boric acid (H₃BO₃), triphenyl borane (B(C₅H₅)₃) and other boron salts, such as sodium borate.

In some embodiments, the disclosed compositions may further comprise brominated organic compounds such as hexabromocyclododecane or decabromodiphenyl oxide. The brominated organic compounds further include aliphatic compounds such as dibromoneopentyl glycol (DBNPG, C(CH₂Br)₂(CH₂OH)₂, Specialchem FR-522); trisbromoneopentyl phosphate (Specialchem FR-370/FR-372, (C(CH₂Br)₃CH₂O)PO), trisbromoneopentyl alcohol (TBNPA, CH₂(CH₂Br)OH), and hexabromocyclododecane (HBCD, cyclo-(—CHBrCHBrCH₂CH₂CHBrCHBrCH₂CH₂CHBrCHBrCH₂CH₂—)).

The brominated organic compounds further include aromatic compounds such as decabromodiphenyl oxide (DECA, O(C₆Br₅)₂, Specialchem FR-1210); tris(tribromophenyl)triazine (Specialchem FR-245); tetrabromobisphenol A bis (2,3-dibromopropyl ether) (Specialchem FR-720,); Octabromodiphenyl oxide (OCTA, Specialchem FR-1208); tetrabromobisphenol A (CH₃)₂C(CH₂Br₂OH)₂, Specialchem FR-1524); and brominated trimethylphenyl indan (Specialchem FR-1808).

The brominated organic compounds that function as flammability reducing additives in the compositions as disclosed herein include brominated epoxy compounds such as Specialchem F-2016 (oligomer), among others. All of the aliphatic brominated, aromatic brominated and brominated epoxy compounds listed above are available from Specialchem S. A. (Paris, France).

Brominated organic compounds also include bromofluoroolefins such as CF₃CBr═CH₂ (1,1,1-trifluoro-2-bromopropene. In some embodiments, the compositions as disclosed herein may further comprise chlorinated paraffins with 10-30 carbon atoms and having from about 35 wt % to about 70 wt % chlorine in the molecule. Chlorinated paraffins include those sold under the trademarks: Chlorez®/Hordaresin® flame retardant additives; Doversperse® dispersions and emulsions of resinous and liquid chlorinated paraffins; Doverguard® brominated chlorinated paraffins; Paroil®; and Chlorowax® liquid chlorinated paraffins; by Dover Chemical Corporation (Dover, Ohio). Additionally, chlorinated paraffins of the present invention include compounds sold under the trademarks: Cereclor® 42, 42SS, 48, 70, LCCP 44, and 46 fire retardant chlorinated paraffin waxes and Cereclor® S-45, 51L, S-52, S-52HV, S-55, S-56, S-56B, and MCCP 54 C₁₄-C₁₇ chlorinated paraffins, by Pioneer (Houston, Tex.).

In some embodiments, the compositions as disclosed herein may further comprise ammonium polyphosphates (APPs), [NH₄PO₃]ₙ as flammability reducing additives. The ammonium polyphosphates may be straight chained or branched and cross-linked molecules. Ammonium polyphosphates are available coated with silanes, melamines or other substances. The present invention is intended to include coated or uncoated ammonium polyphosphate formulations. Representative of these APP formulations are FR CROS 484 (uncoated), RF CROS 486 (surface reacted silane coating), and FR CROS 484 (surface reacted melamine coating), which are all available from Specialchem S. A. (Paris, France).

In some embodiment, the compositions as disclosed herein may further comprise mixtures of water with polyalkylene glycols (PAGs) or polyol ester (POEs) lubricants optionally with anti corrosion, antiwear, stabilizer and/or lubricity additives, as flammability reducing additives. The formulations with water may comprise 30 wt % water or more, such as those sold under the trademark EMKAROX® HV 45 and EMKAROX® HV 20 (PAGs) by Uniqema, Gouda, The Netherlands. As the PAG/water and POE/water as described may also function as a lubricant, additional lubricants may not be necessary. Alternatively, additional lubricants may be added to the PAG/water or POE/water mixtures as may be required for lubrication.

In some embodiments, the compositions as disclosed herein may further comprise perfluorocarbon or perfluoropolyether lubricants as flammability reducing additives. Examples include but are not limited to perfluoropolyethers sold under the trademarks; Krytox® (DuPont, Wilmington, Del.); Fomblin® (Solvay Solexis, Italy); and Demnum™ (offered by Daikin America, Inc., Osaka, Japan). Representative lubricants of this type are Krytox® 1531XP or Krytox® GLP series, Fomblin® Z-Dol, Z-Tetraol, AM 2001, or AM 3001, Demnum™ LR-200 or S-65 and other Demnum™ oils. As said perfluorinated lubricants may also function as a lubricant, no other lubricant may be required in a composition containing said perfluorinated fire hazard-reducing agents. Alternatively, the perfluorinated lubricants may be included as an additive to the other lubricants as described herein.

In some embodiments, the compositions as disclosed herein may further comprise melamines as flammability reducing additives. Such melamines include melamine (2,4,6-triamino-1,3,5-triazine) and homologues and derivatives of melamine. Such melamine homologues include multi-ring structures such as melam (1,3,5-triazine-2,4,6-triamine-n-(4,6-diamino-1,3,5-triazine-2-yl), melem (2,5,8-triamino-1,3,4,6,7,9,9b-heptaazaphenalene), and melon (poly[8-amino-1,3,4,6,7,9,9b-heptaazaphenalene-2,5-diyl)]). Such melamine derivatives include melamine cyanurate and melamine (mono/pyro/poly) phosphates, such as those melamines sold under the trademark Melapur® MP (melamine monophosphate and Melapur® 200 (a melamine polyphosphate) by Specialchem S. A. (Paris, France).

In some embodiments, the compositions disclosed herein may further comprise fluoroketones as flammability reducing additives, wherein said fluoroketones are represented by the formula R¹COR², wherein R¹ and R² are independently selected from straight or branched chain, saturated or unsaturated, aliphatic or alicyclic partially or fully fluorinated hydrocarbon radicals. Additionally, R¹ and R² may be joined to form a cyclic fluoroketone ring. The fluoroketones may contain from about 2 to 10 carbon atoms. Preferred fluoroketones contain 4 to 8 carbon atoms. The fluoroketones of the present invention may further contain heteroatoms, such as oxygen, thus forming additional ketone groups, ether groups, aldehyde groups, or ester groups. Examples of such fluoroketones are 1,1,1,2,2,4,5,5,5-nonafluoro-4-(trifluoromethyl)-3-pentanone or perfluoroethyl isopropyl ketone (PEIK); 1,1,1,3,4,4,4-heptafluoro-3-(trifluoromethyl)-2-butanone or perfluoromethyl isopropyl ketone (PMIK); 1,1,1,2,4,5,5,5-octafluoro-2,4-bis(trifluoromethyl)-3-pentanone; 1,1,1,2,4,4,5,5-octafluoro-2-(trifluoromethyl)-3-pentanone; 1,1,1,2,4,4,5,5,6,6,6-undecafluoro-2-(trifluoromethyl)-3-hexanone; and 1,1,2,2,4,5,5,5-octafluoro-1-(trifluoromethoxy)-4-(trifluoromethyl)-3-pentanone. PEIK is available from 3M™ (St. Paul, Minn.) and the other fluoroketones listed may be prepared as described in U.S. Pat. Nos. 3,185,734 and 6,478,979 incorporated herein by reference, and J. Am. Chem. Soc., vol 84, pp. 4285-88, 1962.

In some embodiments, the compositions as disclosed herein may further comprise fluoroiodo compounds such as trifluoromethyl iodide (CF₃I,), as flammability reducing additives.

The concentration of the flammability reducing additives will vary depending upon the flammability characteristics of the composition to which these additives will be added. The concentration of the flammability reducing additives in any of the disclosed compositions may be sufficient to reduce flammability to an acceptable level or eliminate the flammability of said composition entirely. In one embodiment, the concentration of flammability reducing additive with respect to the disclosed compositions may be from about greater than 0 wt % to about 50 wt % based on the total composition. In another embodiment the concentration of flammability reducing additive will be from about 0.1 wt % to about 20 wt %. In another embodiment, the concentration of the flammability reducing additive will be from about 0.1 wt % to about 5 wt % based on the total composition. And further in another embodiment, the concentration of the flammability reducing additive will be from about 0.1 wt % to less than 1.0 wt %.

In some embodiments, the disclosed compositions include at least one dye. In some embodiments, the disclosed compositions include at least one ultra-violet (UV) dye.

In some embodiments, the disclosed compositions include at least one UV dye that is a fluorescent dye. In some embodiments, the described compositions include at least one UV dye that is a fluorescent dye selected from the group consisting of naphthalimides, perylenes, coumarins, anthracenes, phenanthracenes, xanthenes, thioxanthenes, naphthoxanthenes, fluoresceins, and derivatives of said dye and combinations thereof.

In some embodiments, the disclosed compositions contain from about 0.001 wt % to about 1.0 wt % UV dye. In other embodiments, the UV dye is present in an amount of from about 0.005 wt % to about 0.5 wt %; and in other embodiments, the UV dye is present in an amount of from 0.01 wt % to about 0.25 wt % of the total composition.

In some embodiments, the UV dye is a useful component for detecting leaks of the composition by permitting one to observe the fluorescence of the dye at or in the vicinity of a leak point in an apparatus (e.g., refrigeration unit, air-conditioner or heat pump). One may observe the UV emission, e.g., fluorescence from the dye under an ultra-violet light. Therefore, if a composition containing such a UV dye is leaking from a given point in an apparatus, the fluorescence can be detected at the leak point, or in the vicinity of the leak point.

In some embodiments, the described compositions further contain at least one solubilizing agent selected to improve the solubility of one or more dye in the disclosed compositions. In some embodiments, the weight ratio of dye to solubilizing agent ranges from about 99:1 to about 1:1.

In some embodiments, solubilizing agents in the disclosed compositions include at least one compound selected from the group consisting of hydrocarbons, hydrocarbon ethers, polyoxyalkylene glycol ethers (such as dipropylene glycol dimethyl ether), amides, nitriles, ketones, chlorocarbons (such as methylene chloride, trichloroethylene, chloroform, or mixtures thereof), esters, lactones, aromatic ethers, fluoroethers and 1,1,1-trifluoroalkanes and mixtures thereof.

In some embodiments, at least one compatibilizer is selected to improve the compatibility of one or more lubricant with the disclosed compositions. In some embodiments, the compatibilizer is selected from the group consisting of hydrocarbons, hydrocarbon ethers, polyoxyalkylene glycol ethers (such as dipropylene glycol dimethyl ether), amides, nitriles, ketones, chlorocarbons (such as methylene chloride, trichloroethylene, chloroform, or mixtures thereof), esters, lactones, is aromatic ethers, fluoroethers, 1,1,1-trifluoroalkanes, and mixtures thereof.

In some embodiments, one or more solubilizing agent and/or compatibilizer is selected from the group consisting of hydrocarbon ethers consisting of the ethers containing only carbon, hydrogen and oxygen, such as dimethyl ether (DME) and mixtures thereof.

In some embodiments, the disclosed composition includes at least one linear or cyclic aliphatic or aromatic hydrocarbon compatibilizer containing from 5 to 15 carbon atoms. In some embodiments, the compatibilizer is selected from the group consisting of at least one hydrocarbon; in other embodiments, the compatibilizer is a hydrocarbon selected from the group consisting of at least pentane, hexane, octane, nonane, decane, commercially available from Exxon Chemical (USA) under the trademarks Isopar® H (a high purity C₁₁ to C₁₂ iso-paraffinic), Aromatic 150 (a C₉ to C₁₁ aromatic), Aromatic 200 (a C₉ to C₁₅ aromatic) and Naptha 140 and mixtures thereof.

In some embodiments, the disclosed compositions include at least one polymeric compatibilizer. In some embodiments, the disclosed compositions include at least one a polymeric compatibilizer selected from those that are random copolymers of fluorinated and non-fluorinated acrylates, wherein the polymer comprises repeating units of at least one monomer represented by the formulae CH₂═C(R¹)CO₂R², CH₂═C(R³)C₆H₄R⁴, and CH₂═C(R⁵)C₆H₄XR⁶, wherein X is oxygen or sulfur; R¹, R³, and R⁵ are independently selected from the group consisting of H and C₁-C₄ alkyl radicals; and R², R⁴, and R⁶ are independently selected from the group consisting of carbon-chain-based radicals containing C, and F, and may further contain H, Cl, ether oxygen, or sulfur in the form of thioether, sulfoxide, or sulfone groups and mixtures thereof. Examples of such polymeric compatibilizers include those commercially available from E. I. du Pont de Nemours & Co. (Wilmington, Del., 19898, USA) under the trademark Zonyl® PHS. Zonyl® PHS is a random copolymer made by polymerizing 40 wt % CH₂═C(CH₃)CO₂CH₂CH₂(CF₂CF₂)ₘF (also referred to as Zonyl® is fluoromethacrylate or ZFM) wherein m is from 1 to 12, primarily 2 to 8, and 60 wt % lauryl methacrylate (CH₂═C(CH₃)CO₂(CH₂)₁₁CH₃, also referred to as LMA).

In some embodiments, the compatibilizer component contains from about 0.01 to 30 wt % (based on total amount of compatibilizer) of an additive which reduces the surface energy of metallic copper, aluminum, steel, or other metals and metal alloys thereof found in heat exchangers in a way that reduces the adhesion of lubricants to the metal. Examples of metal surface energy reducing additives include those commercially available from DuPont under the trademarks Zonyl® FSA, Zonyl® FSP, and Zonyl® FSJ.

In some embodiments, the disclosed compositions further include metal surface deactivators. In some embodiments, at least one metal surface deactivator is selected from the group consisting of areoxalyl bis (benzylidene) hydrazide (CAS reg no. 6629-10-3), N,N′-bis(3,5-di-tert-butyl-4-hydroxyhydrocinnamoylhydrazine (CAS reg no. 32687-78-8), 2,2,′-oxamidobis-ethyl-(3,5-di-tert-butyl-4-hydroxyhydrocinnamate (CAS reg no, 70331-94-1), N,N′-(disalicyclidene)-1,2-diaminopropane (CAS reg no. 94-91-7) and ethylenediaminetetra-acetic acid (CAS reg no. 60-00-4) and its salts, and mixtures thereof.

In some embodiments, the compositions disclosed herein further include at least one stabilizer selected from the group consisting of phenols, thiophosphates, butylated triphenylphosphorothionates, organo phosphates, or phosphites, aryl alkyl ethers, terpenes, terpenoids, epoxides, fluorinated epoxides, oxetanes, ascorbic acid, thiols, lactones, thioethers, amines, nitromethane, alkylsilanes, benzophenone derivatives, aryl sulfides, divinyl terephthalic acid, diphenyl terephthalic acid, ionic liquids, and mixtures thereof.

Of note are stabilizers such as phenols, epoxides, amines, phosphates, phosphites and nitromethane for use with the compositions of the present invention.

Of particular note are stabilizers such as hindered phenols and hindered amine light stabilizers.

In some embodiments, said at least one stabilizer is selected from the group consisting of tocopherol; hydroquinone; t-butyl hydroquinone; monothiophosphates; and dithiophosphates, commercially available from Ciba Specialty Chemicals, Basel, Switzerland, hereinafter “Ciba”, under the trademark Irgalube® 63; dialkylthiophosphate esters, commercially available from Ciba under the trademarks Irgalube® 353 and Irgalube® 350, respectively; butylated triphenylphosphorothionates, commercially available from Ciba under the trademark Irgalube® 232; amine phosphates, commercially available from Ciba under the trademark Irgalube® 349 (Ciba); hindered phosphites, commercially available from Ciba as Irgafos® 168 and Tris-(di-tert-butylphenyl)phosphite, commercially available from Ciba under the trademark Irgafos® OPH; (Di-n-octyl phosphite); and iso-decyl diphenyl phosphite, commercially available from Ciba under the trademark Irgafos® DDPP; trialkyl phosphates, such as trimethyl phosphate, triethylphosphate, tributyl phosphate, trioctyl phosphate, and tri(2-ethylhexyl)phosphate; triaryl phosphates including triphenyl phosphate, tricresyl phosphate, and trixylenyl phosphate; and mixed alkyl-aryl phosphates including isopropylphenyl phosphate (IPPP), and bis(t-butylphenyl)phenyl phosphate (TBPP); butylated triphenyl phosphates, such as those commercially available under the trademark Syn-O-Ad® including Syn-O-Ad® 8784; tert-butylated triphenyl phosphates such as those commercially available under the trademark Durad®620; isopropylated triphenyl phosphates such as those commercially available under the trademarks Durad® 220 and Durad®110; anisole; 1,4-dimethoxybenzene; 1,4-diethoxybenzene; 1,3,5-trimethoxybenzene; myrcene, alloocimene, limonene (in particular, d-limonene); retinal; pinene; menthol; geraniol; farnesol; phytol; Vitamin A; terpinene; delta-3-carene; terpinolene; phellandrene; fenchene; dipentene; caratenoids, such as lycopene, beta carotene, and xanthophylls, such as zeaxanthin; retinoids, such as hepaxanthin and isotretinoin; bornane; 1,2-propylene oxide; 1,2-butylene oxide; n-butyl glycidyl ether; trifluoromethyloxirane; 1,1-bis(trifluoromethyl)oxirane; 3-ethyl-3-hydroxymethyl-oxetane, such as OXT-101 (Toagosei Co., Ltd); 3-ethyl-3-((phenoxy)methyl)-oxetane, such as OXT-211 (Toagosei Co., Ltd); 3-ethyl-3-((2-ethyl-hexyloxy)methyl)-oxetane, such as OXT-212 (Toagosei Co., Ltd); ascorbic acid; methanethiol (methyl mercaptan); ethanethiol (ethyl mercaptan); Coenzyme A; dimercaptosuccinic acid (DMSA); grapefruit mercaptan ((R)-2-(4-methylcyclohex-3-enyl)propane-2-thiol)); cysteine ((R)-2-amino-3-sulfanyl-propanoic acid); lipoamide (1,2-dithiolane-3-pentanamide); 5,7-bis(1,1-dimethylethyl)-3-[2,3(or 3,4)-dimethylphenyl]-2(3H)-benzofuranone, commercially available from Ciba under the trademark Irganox® HP-136; benzyl phenyl sulfide; diphenyl sulfide; diisopropylamine; dioctadecyl 3,3′-thiodipropionate, commercially available from Ciba under the trademark Irganox® PS 802 (Ciba); didodecyl 3,3′-thiopropionate, commercially available from Ciba under the trademark Irganox® PS 800; di-(2,2,6,6-tetramethyl-4-piperidyl)sebacate, commercially available from Ciba under the trademark Tinuvin® 770; poly-(N-hydroxyethyl-2,2,6,6-tetramethyl-4-hydroxy-piperidyl succinate, commercially available from Ciba under the trademark Tinuvin® 622LD (Ciba); methyl his tallow amine; his tallow amine; phenol-alpha-naphthylamine; bis(dimethylamino)methylsilane (DMAMS); tris(trimethylsilyl)silane (TTMSS); vinyltriethoxysilane; vinyltrimethoxysilane; 2,5-difluorobenzophenone; 2′,5′-dihydroxyacetophenone; 2-aminobenzophenone; 2-chlorobenzophenone; benzyl phenyl sulfide; diphenyl sulfide; dibenzyl sulfide; ionic liquids; and mixtures and combinations thereof.

In some embodiments, the disclosed composition includes at least one ionic liquid stabilizer selected from the group consisting of organic salts that are liquid at room temperature (approximately 25° C.), those salts containing cations selected from the group consisting of pyridinium, pyridazinium, pyrimidinium, pyrazinium, imidazolium, pyrazolium, thiazolium, oxazolium and triazolium and mixtures thereof; and anions selected from the group consisting of [BF₄]—, [PF₆]—, [SbF₆]—, [CF₃SO₃]—, [HCF₂CF₂SO₃]—, [CF₃HFCCF₂SO₃]—, [HCClFCF₂SO₃]—, [(CF₃SO₂)₂N]—, [(CF₃CF₂SO₂)₂N]—, [(CF₃SO₂)₃C]—, [CF₃CO₂]—, and F— and mixtures thereof. In some embodiments, 8 ionic liquid stabilizers are selected from the group consisting of emim BF₄ (1-ethyl-3-methylimidazolium tetrafluoroborate); bmim BF₄ (1-butyl-3-methylimidazolium tetraborate); emim PF₆ (1-ethyl-3-methylimidazolium hexafluorophosphate); and bmim PF₆ (1-butyl-3-methylimidazolium hexafluorophosphate), all of which are available from Fluka (Sigma-Aldrich).

In some embodiments, at least one stabilizer is a hindered phenol, which are any substituted phenol compound including phenols comprising one or more substituted or cyclic, straight chain, or branched aliphatic substituent group, such as, alkylated monophenols including 2,6-di-tert-butyl-4-methylphenol; 2,6-di-tert-butyl-4-ethylphenol; 2,4-dimethyl-6-tertbutylphenol; tocopherol; and the like, hydroquinone and alkylated hydroquinones including t-butyl hydroquinone, other derivatives of hydroquinone; and the like, hydroxylated thiodiphenyl ethers, including 4,4′-thio-bis(2-methyl-6-tert-butylphenol); 4,4′-thiobis(3-methyl-6-tertbutylphenol); 2,2′-thiobis(4methyl-6-tert-butylphenol); and the like, alkylidene-bisphenols including: 4,4′-methylenebis(2,6-di-tert-butylphenol); 4,4′-bis(2,6-di-tert-butylphenol); derivatives of 2,2′- or 4,4-biphenoldiols; 2,2′-methylenebis(4-ethyl-6-tertbutylphenol); 2,2′-methylenebis(4-methyl-6-tertbutylphenol); 4,4-butylidenebis(3-methyl-6-tert-butylphenol); 4,4-isopropylidenebis(2,6-di-tert-butylphenol); 2,2′-methylenebis(4-methyl-6-nonylphenol); 2,2′-isobutylidenebis(4,6-dimethylphenol; 2,2′-methylenebis(4-methyl-6-cyclohexylphenol, 2,2- or 4,4-biphenyldiols including 2,2′-methylenebis(4-ethyl-6-tert-butylphenol); butylated hydroxytoluene (BHT, or 2,6-di-tert-butyl-4-methylphenol), bisphenols comprising heteroatoms including 2,6-di-tert-alpha-dimethylamino-p-cresol, 4,4-thiobis(6-tert-butyl-m-cresol); and the like; acylaminophenols; 2,6-di-tert-butyl-4(N,N′-dimethylaminomethylphenol); sulfides including; bis(3-methyl-4-hydroxy-5-tert-butylbenzyl)sulfide; bis(3,5-di-tert-butyl-4-hydroxybenzyl)sulfide and mixtures and combinations thereof.

In some embodiments, the disclosed compositions contain at least one tracer. Addition of a tracer to a composition allows the detection of dilution, adulteration, contamination or counterfeit product. In some embodiments, the tracer additive in the disclosed compositions consists of two or more tracer compounds from the same class of compounds or two or more tracer compounds from different classes of compounds.

In some embodiments, the tracer component or tracer blend is present in the compositions at a total concentration of about 50 parts per million by weight (ppm) to about 1000 ppm. In other embodiments, the tracer compound or tracer blend is present at a total concentration of about 50 ppm to about 500 ppm. In other embodiments, the tracer compound or tracer blend is present at a total concentration of about 50 ppm to about 300 ppm. In other embodiments, the tracer compound or tracer blend is present at a total concentration of about 50 ppm to about 150 ppm.

In some embodiments, the disclosed compositions include at least one tracer selected from the group consisting of hydrofluorocarbons (HFCs), deuterated hydrofluorocarbons, perfluorocarbons, fluoroethers, brominated compounds, iodated compounds, alcohols, aldehydes and ketones, nitrous oxide and combinations thereof. Some embodiments of the disclosed compositions include at least one tracer selected from the group consisting of fluoroethane, 1,1,-difluoroethane, 1,1,1-trifluoroethane, 1,1,1,3,3,3-hexafluoropropane, 1,1,1,2,3,3,3-heptafluoropropane, 1,1,1,3,3-pentafluoropropane, 1,1,1,3,3-pentafluorobutane, 1,1,1,2,3,4,4,5,5,5-decafluoropentane, 1,1,1,2,2,3,4,5,5,6,6,7,7,7-tridecafluoroheptane, iodinetrifluoromethane, deuterated hydrocarbons, deuterated hydrofluorocarbons, perfluorocarbons, fluoroethers, brominated compounds, iodated compounds, alcohols, aldehydes, ketones, nitrous oxide (N₂O) and mixtures thereof. In some embodiments, the tracer additive is a tracer blend containing two or more hydrofluorocarbons, or one hydrofluorocarbon in combination with one or more perfluorocarbons.

In some embodiments, at least one tracer composition is added to the disclosed compositions in previously determined quantities to allow detection of any dilution, contamination or other alteration of the composition. Additionally, it is possible to detect the sale of counterfeit product when the tracer is determine to be absent.

In other embodiments, the compositions disclosed herein may further include a perfluoropolyether. A common characteristic of perfluoropolyethers is the presence of perfluoroalkyl ether moieties. Perfluoropolyether is synonymous to perfluoropolyalkylether. Other synonymous terms frequently used include “PFPE”, “PFAE”, “PFPE oil”, “PFPE fluid”, and “PFPAE”. In some embodiments, the perfluoropolyether has the formula of CF₃—(CF₂)₂—O—[CF(CF₃)—CF₂—O]j′-R′f, and is commercially available from DuPont under the trademark Krytox®. In the immediately preceding formula, j′ is 2-100, inclusive and R′f is CF₂CF₃, a C3 to C6 perfluoroalkyl group, or combinations thereof.

Other PFPEs, commercially available from Ausimont of Milan, Italy, and Montedison S.p.A, of Milan, Italy, under the trademarks Fomblin® and Galden®, respectively, and produced by perfluoroolefin photooxidation, can also be used.

PFPE commercially available under the trademark Fomblin®-Y can have the formula of CF₃O(CF₂CF(CF₃)—O—)_{m′}(CF₂—O—)_{n′}—R_{1f}. Also suitable is CF₃O[CF₂CF(CF₃)O]_{m′}(CF₂CF₂O)_{o′}(CF₂O)_{n′}—R_{1f}. In the formulae R_{1f} is CF₃, C₂F₅, C₃F₇, or combinations of two or more thereof; (m′+n′) is 8-45, inclusive; and min is 20-1000, inclusive; o′ is 1; (m′+n′+o′) is 8-45, inclusive; m′/n′ is 20-1000, inclusive.

PFPE commercially available under the trademark Fomblin®-Z can have the formula of CF₃O(CF₂CF₂—O—)_{p′}(CF₂—O)_{q′}CF₃ where (p′+q′) is 40-180 and p′/q′ is 0.5-2, inclusive.

Another family of PFPE, commercially available under the trademark Demnum™ from Daikin Industries, Japan, can also be used. It can be produced by sequential oligomerization and fluorination of 2,2,3,3-tetrafluorooxetane, yielding the formula of F—[(CF₂)₃—O]_{t′}—R_{2f} where R_{2f} is CF₃, C₂F₅, or combinations thereof and t′ is 2-200, inclusive.

In some embodiments, the PFPE is unfunctionalized. In an unfunctionalized perfluoropolyether, the end group can be branched or straight chain perfluoroalkyl radical end groups. Examples of such perfluoropolyethers can have the formula of C_{r′}F_{(2r′+1)}-A-C_{r′}F₍₂ᵣ₊₁₎ in which each r′ is independently 3 to 6; A can be O—(CF(CF₃)CF₂—O)_{w′}, O—(CF₂—O)_{x′}(CF₂CF₂—O)_{y′}, O—(C₂F₄—O)_{w′}, O—(C₂F₄—O)_{x′}(C₃F₆—O)_{y′}, O—(CF(CF₃)CF₂—O)_{x′}(CF₂—O)_{y′}, O—(CF₂CF₂CF₂—O)_{w′}, O—(CF(CF₃)CF₂—O)_{x′}(CF₂CF₂—O)_{y′}—(CF₂—O)_{z′}, or combinations of two or more thereof; preferably A is O—(CF(CF₃)CF₂—O)_{w′}, O—(C₂F₄—O)_{w′}, O—(C₂F₄—O)_{x′}(C₃F₆—O), O—(CF₂CF₂CF₂—O)_{w′}, or combinations of two or more thereof; w′ is 4 to 100; x′ and y′ are each independently 1 to 100. Specific examples include, but are not limited to, F(CF(CF₃)—CF₂—O)₉—CF₂CF₃, F(CF(CF₃)—CF₂—O)₉—CF(CF₃)₂, and combinations thereof. In such PFPEs, up to 30% of the halogen atoms can be halogens other than fluorine, such as, for example, chlorine atoms.

In other embodiments, the two end groups of the perfluoropolyether, independently, may be functionalized by the same or different groups. A functionalized PFPE is a PFPE wherein at least one of the two end groups of the perfluoropolyether has at least one of its halogen atoms substituted by a group selected from esters, hydroxyls, amines, amides, cyanos, carboxylic acids, sulfonic acids or combinations thereof.

In some embodiments, representative ester end groups include —COOCH₃, —COOCH₂CH₃, —CF₂COOCH₃, —CF₂COOCH₂CH₃, —CF₂CF₂COOCH₃, —CF₂CF₂COOCH₂CH₃, —CF₂CH₂COOCH₃, —CF₂CF₂CH₂COOCH₃, —CF₂CH₂CH₂COOCH₃, —CF₂CF₂CH₂CH₂COOCH₃.

In some embodiments, representative hydroxyl end groups include —CF₂OH, —CF₂CF₂OH, —CF₂CH₂OH, —CF₂CF₂CH₂OH, —CF₂CH₂CH₂OH, —CF₂CF₂CH₂CH₂OH.

In some embodiments, representative amine end groups include —CF₂NR¹R², —CF₂CF₂NR¹R², —CF₂CH₂NR¹R², —CF₂CF₂CH₂NR¹R², —CF₂CH₂CH₂NR¹R², —CF₂CF₂CH₂CH₂NR¹R², wherein R¹ and R² are independently H, CH₃, or CH₂CH₃.

In some embodiments, representative amide end groups include —CF₂C(O)NR¹R², —CF₂CF₂C(O)NR¹R², —CF₂CH₂C(O)NR¹R², —CF₂CF₂CH₂C(O)NR¹R², —CF₂CH₂CH₂C(O)NR¹R², —CF₂CF₂CH₂CH₂C(O)NR¹R², wherein R¹ and R² are independently H, CH₃, or CH₂CH₃.

In some embodiments, representative cyano end groups include —CF₂CN, —CF₂CF₂CN, —CF₂CH₂CN, —CF₂CF₂CH₂CN, —CF₂CH₂CH₂CN, —CF₂CF₂CH₂CH₂CN.

In some embodiments, representative carboxylic acid end groups include —CF₂COOH, —CF₂CF₂COOH, —CF₂CH₂COOH, —CF₂CF₂CH₂COOH, —CF₂CH₂CH₂COOH, —CF₂CF₂CH₂CH₂COOH.

In some embodiments, the sulfonic acid end groups is selected from the group consisting of —S(O)(O)OR³, —S(O)(O)R⁴, —CF₂OS(O)(O)OR³, —CF₂CF₂OS(O)(O)OR³, —CF₂CH₂OS(O)(O)OR³, —CF₂CF₂CH₂OS(O)(O)OR³, —CF₂CH₂CH₂OS(O)(O)OR³, —CF₂CF₂CH₂CH₂OS(O)(O)OR³, —CF₂S(O)(O)OR³, —CF₂CF₂S(O)(O)OR³, —CF₂CH₂S(O)(O)OR³, —CF₂CF₂CH₂S(O)(O)OR³, —CF₂CH₂CH₂S(O)(O)OR³, —CF₂CF₂CH₂CH₂S(O)(O)OR³, —CF₂OS(O)(O)R⁴, —CF₂CF₂OS(O)(O)R⁴, —CF₂CH₂OS(O)(O)R⁴, —CF₂CF₂CH₂OS(O)(O)R⁴, —CF₂CH₂CH₂OS(O)(O)R⁴, —CF₂CF₂CH₂CH₂OS(O)(O)R⁴, wherein R³ is H, CH₃, CH₂CH₃, CH₂CF₃, CF₃, or CF₂CF₃, R⁴ is CH₃, CH₂CH₃, CH₂CF₃, CF₃, or CF₂CF₃.

In some embodiments, the disclosed compositions include additives that are members of the triaryl phosphate family of EP (extreme pressure) lubricity additives, such as butylated triphenyl phosphates (BTPP), or other alkylated triaryl phosphate esters, e.g. Syn-0-Ad® 8478 from Akzo Chemicals, tricresyl phosphates and related compounds. Additionally, the metal dialkyl dithiophosphates (e.g., zinc dialkyl dithiophosphate (or ZDDP), including the commercially available Lubrizol 1375 and other members of this family of chemicals is used in compositions of the disclosed compositions. Other antiwear additives include natural product oils and asymmetrical polyhydroxyl lubrication additives, such as the commercially available Synergol TMS (International Lubricants).

In some embodiments, stabilizers such as antioxidants, free radical scavengers, and water scavengers and mixtures thereof are included. Such additives in this category can include, but are not limited to, butylated hydroxy toluene (BHT), epoxides, and mixtures thereof. Corrosion inhibitors include dodecyl succinic acid (DDSA), amine phosphate (AP), oleoyl sarcosine, imidazone derivatives and substituted sulfphonates.

In one embodiment, the compositions disclosed herein may be prepared by any convenient method to combine the desired amounts of the individual components. A preferred method is to weigh the desired component amounts and thereafter combine the components in an appropriate vessel. Agitation may be used, if desired.

Also disclosed herein is a foam blowing agent comprising a composition of the present invention. Also disclosed herein is a sprayable composition comprising the composition of the present invention.

### Methods and Processes

In one embodiment, a process is provided to produce cooling comprising condensing a composition of the present invention and thereafter evaporating said composition in the vicinity of a body to be cooled.

A body to be cooled is defined as any space, location, object or body from which it is desirable to add, transfer, move or remove heat. Examples of bodies to be cooled are spaces (open or enclosed) requiring refrigeration or cooling, such as refrigerator or freezer cases in a supermarket, building spaces requiring air-conditioning, industrial water chillers or the passenger compartment of an automobile requiring air-conditioning.

By in the vicinity or is meant that the cooling occurs in proximity to the body to be cooled. For instance, the evaporator of a residential air is conditioner is contained within the air conditioner and then air is blown across the evaporator in the direction of the room to be cooled. In the case of a chiller that is cooling a secondary loop fluid, the evaporator is contained within the chiller and the secondary loop fluid is the body to be cooled and runs through the chiller in thermal contact with the evaporating refrigerant composition. In a supermarket refrigeration case, the compressor and condenser of the vapor compression system resides remotely in a back room or on a roof and the evaporator is located directly adjacent to the refrigeration case to be cooled.

In another embodiment, a process is provided to produce heat comprising condensing the composition of the present invention in the vicinity of a body to be heated and thereafter evaporating said composition.

A body to be heated is defined as any space, location, object or body from which it is desirable to add heat as for instance with a heat pump. Examples of bodies to be heated are spaces (open or enclosed) requiring heating, such as building spaces requiring heating during cold weather, industrial process streams requiring elevated temperatures, and hot water heaters used for residential or industrial hot water.

In another embodiment, disclosed is a method of using the composition of the present invention as a heat transfer fluid composition. The method comprises transporting said composition from a heat source to a heat sink.

A heat source is defined as any space, location, object or body from which it is desirable to add, transfer, move or remove heat. Examples of heat sources are spaces (open or enclosed) requiring refrigeration or cooling, such as refrigerator or freezer cases in a supermarket, building spaces requiring air-conditioning, industrial water chillers or the passenger compartment of an automobile requiring air-conditioning. In some embodiments, the heat transfer composition may remain in a constant state throughout the transfer process (i.e., not evaporate or condense). In other embodiments, evaporative cooling processes may utilize heat is transfer compositions as well.

A heat sink is defined as any space, location, object or body capable of absorbing heat. A vapor compression refrigeration system is one example of such a heat sink.

Vapor-compression refrigeration, air-conditioning, or heat pump systems include an evaporator, a compressor, a condenser, and an expansion device. A vapor-compression cycle re-uses refrigerant in multiple steps producing a cooling effect in one step and a heating effect in a different step. The cycle can be described simply as follows. Liquid refrigerant enters an evaporator through an expansion device, and the liquid refrigerant boils in the evaporator, by withdrawing heat from the environment, at a low temperature to form a gas and produce cooling. The low-pressure gas enters a compressor where the gas is compressed to raise its pressure and temperature. The higher-pressure (compressed) gaseous refrigerant then enters the condenser in which the refrigerant condenses and discharges its heat to the environment. The refrigerant returns to the expansion device through which the liquid expands from the higher-pressure level in the condenser to the low-pressure level in the evaporator, thus repeating the cycle.

In another embodiment, the present invention relates to foam expansion agent compositions comprising the compositions of the present invention as described herein for use in preparing foams. In other embodiments the invention provides foamable compositions, and preferably polyurethane and polyisocyanate foam compositions, and method of preparing foams. In such foam embodiments, one or more of the present compositions are included as a foam expansion agent in foamable compositions, which composition preferably includes one or more additional components capable of reacting and foaming under the proper conditions to form a foam or cellular structure.

The present invention further relates to a method of forming a foam comprising: (a) adding a composition of the present invention to a is foamable composition; and (b) reacting the foamable composition under conditions effective to form a foam.

Another embodiment of the present invention relates to the use of the compositions as described herein for use as propellants in sprayable compositions. Additionally, the present invention relates to a sprayable composition comprising the compositions as described herein. The active ingredient to be sprayed together with inert ingredients, solvents and other materials may also be present in a sprayable composition. Preferably, the sprayable composition is an aerosol. Suitable active materials to be sprayed include, without limitations, cosmetic materials, such as deodorants, perfumes, hair sprays, cleaners, and polishing agents as well as medicinal materials such as anti-asthma and anti-halitosis medications.

The present invention further relates to a process for producing aerosol products comprising the step of adding a composition of the present invention to active ingredients in an aerosol container, wherein said composition functions as a propellant.

The compositions as disclosed herein are also useful as power cycle working fluids, e.g., organic Rankine cycle (ORC) fluids.

The present invention relates to a process for recovering heat comprising evaporating a liquid phase working fluid comprising a composition as disclosed herein in a heat exchanger in contact with a system that provides heat thus producing a vapor phase working fluid and passing said vapor phase working fluid to an expander wherein mechanical energy is produced. The process may further comprise condensing said vapor phase working fluid thus forming a liquid phase working fluid. The process may further comprise recycling said liquid phase working fluid to the first step and the cycle repeats.

The system that provides heat may be selected from fuel cells, internal combustion engines, internal compression engines, external combustion engines and turbines. Other sources of heat may be sources of waste is heat. It may come from heat and power plants (for example a small scale cogeneration plant on a domestic water heater), or from industrial and farming processes such as organic products fermentation, hot exhausts from ovens or furnaces, flue gas condensation, exhaust gases from vehicles, intercooling of a compressor, or condenser of another power cycle. Other sources of heat may be found in association with operations at oil refineries, petrochemical plants, oil and gas pipelines, chemical industry, glass industry, foundries, smelting, biomass combustion, geothermal heat, solar ponds, air-conditioning, refrigeration and central heating. The vapor phase working fluid is routed to the expander to produce mechanical shaft power. The shaft power can be used to do any mechanical work by employing conventional arrangements of belts, pulleys, gears, transmissions or similar devices depending on the desired speed and torque required. The shaft may be connected to an electric power-generating device such as an induction generator. The electricity produced can be used locally or delivered to a grid.

The compositions of the present invention are also useful in methods for replacing existing refrigerants which may, for example, contribute to global warming. Accordingly a method is provided for replacing a first refrigerant selected from the group consisting of R134a, R22, R12, R124, R404A, R410A, R407C, R413A, R417A, R422A, R422B, R422C and R422D, R423A, R424A, R426A, R428A, R430A, R434A, R437A, R438A, R507A, and R502 in a system that uses, used or was designed to use said first refrigerant said method comprising providing a composition of the present invention to said system.

Of note are methods for replacing R22, R407C, and R410A, wherein the composition used as the replacement comprises HFC-245cb, HFC-32 and one of HFO-1234yf, trans-HFO-1234ze or HFO-1243zf.

Also of note are methods for replacing R134a or R124, wherein the composition used as the replacement comprises HFC-245cb, one of HFO-1234yf, trans-HFO-1234ze or HFO-1243zf, and optionally HFC-134a.

### Apparatus

The compositions of the present invention are useful in systems used to transfer heat. Accordingly, a refrigeration, air conditioning or heat pump apparatus is provided comprising a compressor, a condenser, an expansion device and an evaporator wherein the apparatus contains a composition of the present invention.

A heat transfer system is the system (or apparatus) used to produce a heating or cooling effect in a particular space. A heat transfer system may be a mobile system or a stationary system. The compositions of the present invention are useful in mobile and stationary systems.

Examples of heat transfer systems included but are not limited to air conditioners, freezers, refrigerators, heat pumps, water chillers, flooded evaporator chillers, direct expansion chillers, walk-in coolers, supermarket systems, heat pumps, mobile refrigerators, mobile air conditioning units and combinations thereof.

Mobile heat transfer system refers to any refrigeration, air conditioner, or heating apparatus incorporated into a transportation unit for the road, rail, sea or air. In addition, mobile refrigeration or air conditioner units, include those apparatus that are independent of any moving carrier and are known as “intermodal” systems. Such intermodal systems include “container’ (combined sea/land transport) as well as “swap bodies” (combined road/rail transport).

Stationary heat transfer systems are systems that are fixed in place during operation. A stationary heat transfer system may be associated within or attached to buildings of any variety or may be stand alone devices located out of doors, such as a soft drink vending machine. These stationary applications may be stationary air conditioning and heat pumps (including but not limited to chillers, high temperature heat pumps, residential, commercial or industrial air conditioning systems, and including window, ductless, ducted, packaged terminal, chillers, and those exterior but connected to the building such as rooftop systems). In stationary refrigeration applications, the disclosed compositions may be useful in equipment including commercial, industrial or residential refrigerators and freezers, ice machines, self-contained coolers and freezers, flooded evaporator chillers, direct expansion chillers, walk-in and reach-in coolers and freezers, and combination systems. In some embodiments, the disclosed compositions may be used in supermarket refrigeration systems. Additionally, stationary systems include secondary loop systems that utilize a primary refrigerant and a secondary heat transfer fluid, such that the vapor compression system functions to cool the secondary heat transfer fluid, which then flows to the body to be cooled.

### EXAMPLES

The concepts disclosed herein will be further described in the following examples, which do not limit the scope of the invention described in the claims.

### Example 1

### Impact of Vapor Leakage

A vessel is charged with an initial composition at 0° C., and the initial vapor pressure of the composition is measured. The composition is allowed to leak from the vessel, while the temperature is held constant, until 50 wt % of the initial composition is removed, at which time the vapor pressure of the composition remaining in the vessel is measured. Table 3 lists the data for vapor pressure.

TABLE 3

| | | | | | |
|---|---|---|---|---|---|
| | | | After | After | |
| | | | 50% | 50% | |
| Composition | Initial P | Initial P | Leak | Leak | Delta P |
| wt % | (Psia) | (kPa) | (Psia) | (kPa) | (%) |

HFO-1234yf/HFC-245cb

| | | | | | |
|---|---|---|---|---|---|
| 1/99 | 67.7 | 466.8 | 67.6 | 466.1 | 0.1% |
| 10/90 | 70.7 | 487.5 | 69.9 | 481.9 | 1.1% |
| 20/80 | 74.0 | 510.2 | 72.6 | 500.6 | 1.9% |
| 30/70 | 77.5 | 534.3 | 75.5 | 520.6 | 2.6% |
| 40/60 | 81.0 | 558.5 | 78.7 | 542.6 | 2.8% |
| 50/50 | 84.5 | 582.6 | 82.0 | 565.4 | 3.0% |
| 60/40 | 87.9 | 606.1 | 85.6 | 590.2 | 2.6% |
| 70/30 | 91.1 | 628.1 | 89.2 | 615.0 | 2.1% |
| 80/20 | 94.0 | 648.1 | 92.8 | 639.8 | 1.3% |
| 90/10 | 96.4 | 664.7 | 96.0 | 661.9 | 0.4% |
| 99/1 | 98.2 | 677.1 | 98.2 | 677.1 | 0.0% |
| 99.9/0.1 | 98.3 | 677.8 | 98.3 | 677.8 | 0.0% |

trans-HFO-1234ze/HFC-245cb

| | | | | | |
|---|---|---|---|---|---|
| 55.8/44.2 | 88.2 | 608.1 | 88.2 | 608.1 | 0.0% |
| 70/30 | 87.2 | 601.2 | 86.4 | 595.7 | 0.9% |
| 80/20 | 85.3 | 588.1 | 82.5 | 568.8 | 3.3% |
| 90/10 | 81.2 | 559.9 | 76.7 | 528.8 | 5.5% |
| 99/1 | 73.4 | 506.1 | 72.4 | 499.2 | 1.4% |
| 99.9/0.1 | 72.3 | 498.5 | 72.2 | 497.8 | 0.1% |
| 40/60 | 87.0 | 599.8 | 86.1 | 593.6 | 1.0% |
| 30/70 | 84.9 | 585.4 | 82.6 | 569.5 | 2.7% |
| 20/80 | 81.3 | 560.5 | 77.7 | 535.7 | 4.4% |
| 10/90 | 75.7 | 521.9 | 72.2 | 497.8 | 4.6% |
| 1/99 | 68.4 | 471.6 | 67.8 | 467.5 | 0.9% |

HFO-1243zf/HFC-245cb

| | | | | | |
|---|---|---|---|---|---|
| 54.0/46.0 | 88.4 | 609.5 | 88.4 | 609.5 | 0.0% |
| 70/30 | 87.3 | 601.9 | 86.4 | 595.7 | 1.0% |
| 80/20 | 85.4 | 588.8 | 82.8 | 570.9 | 3.0% |
| 90/10 | 81.6 | 562.6 | 77.9 | 537.1 | 4.5% |
| 99/1 | 75.1 | 517.8 | 74.3 | 512.3 | 1.1% |
| 99.9/0.1 | 74.2 | 511.6 | 74.1 | 510.9 | 0.1% |
| 40/60 | 87.5 | 603.3 | 86.8 | 598.5 | 0.8% |
| 20/80 | 82.1 | 566.1 | 78.8 | 543.3 | 4.0% |
| 10/90 | 76.3 | 526.1 | 72.9 | 502.6 | 4.5% |
| 1/99 | 68.5 | 472.3 | 67.9 | 468.2 | 0.9% |

HFO-1234yf/HFC-245cb/HFC-134a

| | | | | | |
|---|---|---|---|---|---|
| 98/1/1 | 98.5 | 679.1 | 98.4 | 678.4 | 0.1% |
| 1/98/1 | 69.3 | 477.8 | 68.1 | 469.5 | 1.7% |
| 1/1/98 | 98.5 | 679.1 | 98.5 | 679.1 | 0.0% |
| 20/60/20 | 89.7 | 618.5 | 86.2 | 594.3 | 3.9% |
| 20/20/60 | 99.7 | 687.4 | 99.5 | 686.0 | 0.2% |
| 60/20/20 | 98.1 | 676.4 | 96.9 | 668.1 | 1.2% |
| 40/30/20 | 97.1 | 669.5 | 95.8 | 660.5 | 1.3% |
| 30/40/30 | 95.3 | 657.1 | 93.6 | 645.4 | 1.8% |
| 30/30/40 | 97.9 | 675.0 | 97.1 | 669.5 | 0.8% |
| 10/80/10 | 81.6 | 562.6 | 76.5 | 527.5 | 6.2% |
| 80/10/10 | 98.8 | 681.2 | 98.1 | 676.4 | 0.7% |
| 10/10/80 | 99.7 | 687.4 | 99.7 | 687.4 | 0.0% |
| 50/30/20 | 95.9 | 661.2 | 94.1 | 648.8 | 1.9% |
| 50/20/30 | 99.1 | 683.3 | 98.2 | 677.1 | 0.9% |
| 30/50/20 | 91.7 | 632.3 | 88.7 | 611.6 | 3.3% |
| 30/20/50 | 99.8 | 688.1 | 99.4 | 685.3 | 0.4% |
| 20/30/50 | 99.4 | 685.3 | 97.8 | 674.3 | 1.6% |
| 20/50/30 | 93.7 | 646.0 | 91.4 | 630.2 | 2.5% |
| 70/20/10 | 96.4 | 664.7 | 95.1 | 655.7 | 1.3% |
| 70/10/20 | 100.3 | 691.5 | 99.6 | 686.7 | 0.7% |
| 10/70/20 | 88.0 | 606.7 | 83.7 | 577.1 | 4.9% |
| 10/20/70 | 99.4 | 685.3 | 99.3 | 684.7 | 0.1% |
| 20/70/10 | 83.9 | 578.5 | 79.4 | 547.7 | 5.3% |
| 20/10/70 | 100.5 | 692.9 | 100.4 | 692.2 | 0.1% |
| 98.9/0.1/1 | 98.7 | 680.5 | 98.6 | 679.8 | 0.1% |
| 90/5/5 | 98.9 | 681.9 | 98.5 | 679.1 | 0.4% |
| 5/90/5 | 75.7 | 521.9 | 71.5 | 493.0 | 5.5% |
| 5/5/90 | 99.2 | 684.0 | 99.1 | 683.3 | 0.1% |

trans-HFO-1234ze/HFC-245cb/HFC-134a

| | | | | | |
|---|---|---|---|---|---|
| 98/1/1 | 74.0 | 510.2 | 72.8 | 501.9 | 1.6% |
| 1/98/1 | 69.9 | 481.9 | 68.3 | 470.9 | 2.3% |
| 1/1/98 | 98.4 | 678.4 | 98.4 | 678.4 | 0.0% |
| 20/60/20 | 91.3 | 629.5 | 89.4 | 616.4 | 2.1% |
| 20/20/60 | 97.9 | 675.0 | 97.7 | 673.6 | 0.2% |
| 60/20/20 | 90.5 | 624.0 | 89.1 | 614.3 | 1.5% |
| 40/30/20 | 94.1 | 648.8 | 93.6 | 645.4 | 0.5% |
| 30/40/30 | 94.5 | 651.6 | 94.0 | 648.1 | 0.5% |
| 30/30/40 | 95.9 | 661.2 | 95.5 | 658.5 | 0.4% |
| 10/80/10 | 84.2 | 580.5 | 79.4 | 547.4 | 5.7% |
| 80/10/10 | 84.5 | 582.6 | 81.2 | 559.9 | 3.9% |
| 10/10/80 | 98.6 | 679.8 | 98.6 | 679.8 | 0.0% |
| 50/30/20 | 92.0 | 634.3 | 91.3 | 629.5 | 0.8% |
| 50/20/30 | 92.9 | 640.5 | 91.9 | 633.6 | 1.1% |
| 30/50/20 | 92.3 | 636.4 | 91.4 | 630.2 | 1.0% |
| 30/20/50 | 96.6 | 666.0 | 96.3 | 664.0 | 0.3% |
| 20/30/50 | 97.2 | 670.2 | 97.0 | 668.8 | 0.2% |
| 20/50/30 | 94.1 | 648.8 | 93.0 | 641.2 | 1.2% |
| 70/20/10 | 87.9 | 606.1 | 86.0 | 593.0 | 2.2% |
| 70/10/20 | 87.8 | 605.4 | 85.2 | 587.4 | 3.0% |
| 10/70/20 | 89.4 | 616.4 | 86.0 | 593.0 | 3.8% |
| 10/20/70 | 98.6 | 679.8 | 98.6 | 679.8 | 0.0% |
| 20/70/10 | 87.3 | 601.9 | 84.3 | 581.2 | 3.4% |
| 20/10/70 | 98.0 | 675.7 | 97.8 | 674.3 | 0.2% |
| 98.9/0.1/1 | 72.9 | 502.6 | 72.5 | 499.9 | 0.5% |
| 90/5/5 | 79.8 | 550.2 | 76.3 | 526.1 | 4.4% |
| 5/90/5 | 77.7 | 535.7 | 72.9 | 502.6 | 6.2% |
| 5/5/90 | 98.6 | 679.8 | 98.6 | 679.8 | 0.0% |

HFO-1243zf/HFC-245cb/HFC-134a

| | | | | | |
|---|---|---|---|---|---|
| 98/1/1 | 75.6 | 521.2 | 74.7 | 515.0 | 1.2% |
| 1/98/1 | 70.0 | 482.6 | 68.4 | 471.6 | 2.3% |
| 1/1/98 | 98.4 | 678.4 | 98.4 | 678.4 | 0.0% |
| 20/60/20 | 91.5 | 630.9 | 89.7 | 618.5 | 2.0% |
| 20/20/60 | 98.0 | 675.7 | 97.8 | 674.3 | 0.2% |
| 60/20/20 | 90.5 | 624.0 | 89.0 | 613.6 | 1.7% |
| 40/30/20 | 94.1 | 648.8 | 93.6 | 645.4 | 0.5% |
| 30/40/30 | 94.5 | 651.6 | 94.0 | 648.1 | 0.5% |
| 30/30/40 | 95.9 | 661.2 | 95.5 | 658.5 | 0.4% |
| 10/80/10 | 84.5 | 582.6 | 79.9 | 550.9 | 5.4% |
| 80/10/10 | 84.8 | 584.7 | 81.8 | 564.0 | 3.5% |
| 10/10/80 | 98.8 | 681.2 | 98.8 | 681.2 | 0.0% |
| 50/30/20 | 91.9 | 633.6 | 91.3 | 629.5 | 0.7% |
| 50/20/30 | 92.9 | 640.5 | 91.8 | 632.9 | 1.2% |
| 30/50/20 | 92.5 | 637.8 | 91.7 | 632.3 | 0.9% |
| 30/20/50 | 96.7 | 666.7 | 96.3 | 664.0 | 0.4% |
| 20/30/50 | 97.3 | 670.9 | 97.1 | 669.5 | 0.2% |
| 20/50/30 | 94.2 | 649.5 | 93.2 | 642.6 | 1.1% |
| 70/20/10 | 87.9 | 606.1 | 86.0 | 593.0 | 2.2% |
| 70/10/20 | 87.9 | 606.1 | 85.5 | 589.5 | 2.7% |
| 10/70/20 | 89.6 | 617.8 | 86.3 | 595.0 | 3.7% |
| 10/20/70 | 98.7 | 680.5 | 98.7 | 680.5 | 0.0% |
| 20/70/10 | 98.1 | 676.4 | 98.0 | 675.7 | 0.1% |
| 20/10/70 | 98.1 | 676.4 | 98.0 | 675.7 | 0.1% |
| 98.9/0.1/1 | 74.7 | 515.0 | 74.4 | 513.0 | 0.4% |
| 90/5/5 | 80.5 | 555.0 | 77.6 | 535.0 | 3.6% |
| 5/90/5 | 78.0 | 537.8 | 73.2 | 504.7 | 6.2% |
| 5/5/90 | 98.7 | 680.5 | 98.7 | 680.5 | 0.0% |

HFO-1234yf/HFC-245cb/HFC-32

| | | | | | |
|---|---|---|---|---|---|
| 1/1/98 | 246.2 | 1697.5 | 246.0 | 1696.1 | 0.1% |
| 5/5/90 | 243.9 | 1681.6 | 242.5 | 1672.0 | 0.6% |
| 10/10/80 | 239.9 | 1654.1 | 236.0 | 1627.2 | 1.6% |
| 15/15/70 | 234.6 | 1617.5 | 227.0 | 1565.1 | 3.2% |
| 10/20/70 | 232.7 | 1604.4 | 224.1 | 1545.1 | 3.7% |
| 20/10/70 | 236.5 | 1630.6 | 230.2 | 1587.2 | 2.7% |
| 20/20/60 | 227.7 | 1569.9 | 214.8 | 1481.0 | 5.7% |
| 10/30/60 | 224.1 | 1545.1 | 209.2 | 1442.4 | 6.6% |
| 30/10/60 | 231.4 | 1595.5 | 221.0 | 1523.8 | 4.5% |
| 25/25/50 | 218.7 | 1507.9 | 198.5 | 1368.6 | 9.2% |
| 20/30/50 | 216.9 | 1495.5 | 195.7 | 1349.3 | 9.8% |
| 30/20/50 | 220.5 | 1520.3 | 201.4 | 1388.6 | 8.7% |
| 49/1/50 | 227.5 | 1568.6 | 213.5 | 1472.0 | 6.2% |
| 40/10/50 | 224.10 | 1545.12 | 207.50 | 1430.67 | 7.4% |

trans HFO-1234ze/HFC-245cb/HFC-32

| | | | | | |
|---|---|---|---|---|---|
| 1/1/98 | 245.4 | 1692.0 | 244.8 | 1687.8 | 0.2% |
| 5/5/90 | 240.6 | 1658.9 | 236.7 | 1632.0 | 1.6% |
| 10/10/80 | 232.7 | 1604.4 | 225.4 | 1554.1 | 3.1% |
| 15/15/70 | 224.2 | 1545.8 | 212.4 | 1464.5 | 5.3% |
| 10/20/70 | 225.7 | 1556.2 | 214.6 | 1479.6 | 4.9% |
| 20/10/70 | 222.7 | 1535.5 | 210.1 | 1448.6 | 5.7% |
| 20/20/60 | 214.2 | 1476.9 | 197.6 | 1362.4 | 7.7% |
| 10/30/60 | 217.3 | 1498.2 | 201.1 | 1386.5 | 7.5% |
| 30/10/60 | 211.3 | 1456.9 | 193.4 | 1333.5 | 8.5% |
| 25/25/50 | 202.4 | 1395.5 | 180.6 | 1245.2 | 10.8% |
| 40/1/59 | 207.4 | 1430.0 | 186.8 | 1287.9 | 9.9% |
| 21/21/58 | 212.0 | 1461.7 | 194.3 | 1339.7 | 8.3% |

HFO-1243zf/HFC-245cb/HFC-32

| | | | | | |
|---|---|---|---|---|---|
| 1/1/98 | 246.0 | 1696.1 | 245.7 | 1694.1 | 0.1% |
| 5/5/90 | 242.6 | 1672.7 | 241.0 | 1661.6 | 0.7% |
| 10/10/80 | 237.5 | 1637.5 | 233.5 | 1609.9 | 1.7% |
| 15/15/70 | 231.3 | 1594.8 | 223.7 | 1542.4 | 3.3% |
| 10/20/70 | 230.8 | 1591.3 | 222.6 | 1534.8 | 3.6% |
| 20/10/70 | 231.8 | 1598.2 | 224.3 | 1546.5 | 3.2% |
| 20/20/60 | 223.7 | 1542.4 | 211.1 | 1455.5 | 5.6% |
| 10/30/60 | 222.7 | 1535.5 | 209.0 | 1441.0 | 6.2% |
| 30/10/60 | 224.4 | 1547.2 | 211.6 | 1458.9 | 5.7% |
| 25/25/50 | 214.1 | 1476.2 | 195.1 | 1345.2 | 8.9% |
| 20/30/50 | 213.7 | 1473.4 | 194.5 | 1341.0 | 9.0% |
| 30/20/50 | 214.4 | 1478.2 | 195.2 | 1345.9 | 9.0% |
| 26/26/48 | 211.8 | 1460.3 | 191.3 | 1319.0 | 9.7% |
| 20/32/48 | 211.4 | 1457.6 | 190.6 | 1314.1 | 9.8% |
| 32/20/48 | 212.2 | 1463.1 | 191.4 | 1319.7 | 9.8% |
| 36/16/48 | 212.4 | 1464.5 | 191.1 | 1317.6 | 10.0% |
| 16/36/48 | 211.0 | 1454.8 | 189.8 | 1308.6 | 10.0% |

The vapor pressure change after 50% of the compositions have leaked, as shown in Table 3, in many cases is less than 10% indicating that many of the compositions as disclosed herein are azeotropic and/or azeotrope-like.

### Example 2

### Global Warming Potentials and Ozone Depletion Potentials

The global warming potential (GWP) and ozone depletion potential (ODP) for several refrigerants currently in use and for several compositions as disclosed herein are provided in Table 4. The GWP for HFC-245 in Table 4 was approximated using the GWP of HFC-245fa (GWP=1030).

TABLE 4

| Comparative Compositions | GWP | ODP |
|---|---|---|
| CFC-12 | 10,900 | 0.8 |
| HCFC-22 | 1,810 | 0.055 |
| HFC-134a | 1,430 | 0 |
| R404A | 3,922 | 0 |
| R410A | 2,088 | 0 |
| R407C | 1,653 | 0 |
| R413A | 2,053 | 0 |
| R417A | 2,346 | 0 |
| R422D | 2,729 | 0 |
| R507A | 3,985 | 0 |
| Composition (wt %) | | |
| 1234yf/245 (95/5 wt %) | 55 | 0 |
| 1234yf/245 (80/20 wt %) | 209 | 0 |
| 1234yf/245 (55/45 wt %) | 466 | 0 |
| 1234yf/245 (52/48 wt %) | 496 | 0 |
| 1234yf/245 (50/50 wt %) | 517 | 0 |
| 1234yf/245 (20/80 wt %) | 825 | 0 |
| 1234ze/245 (95/5 wt %) | 57 | 0 |
| 1234ze/245 (80/20 wt %) | 211 | 0 |
| 1234ze/245 (50/50 wt %) | 518 | 0 |
| 1234ze/245 (20/80 wt %) | 825 | 0 |
| 1243zf/245 (95/5 wt %) | 54 | 0 |
| 1243zf/245 (80/20 wt %) | 208 | 0 |
| 1243zf/245 (50/50 wt %) | 517 | 0 |
| 1243zf/245 (20/80 wt %) | 825 | 0 |
| 1234yf/245/134a (90/5/5 wt %) | 127 | 0 |
| 1234yf/245/134a (70/10/20 wt %) | 392 | 0 |
| 1234yf/245/134a (50/20/30 wt %) | 637 | 0 |
| 1234yf/245/134a (20/30/50 wt %) | 1025 | 0 |
| 1234yf/245/134a (55/40/5 wt %) | 486 | 0 |
| 1234ze/245/134a (90/5/5 wt %) | 128 | 0 |
| 1234ze/245/134a (70/10/20 wt %) | 393 | 0 |
| 1234ze/245/134a (50/20/30 wt %) | 638 | 0 |
| 1234ze/245/134a (20/30/50 wt %) | 1025 | 0 |
| 1234ze/245/134a (55/40/5 wt %) | 487 | 0 |
| 1243zf/245/134a (90/5/5 wt %) | 126 | 0 |
| 1243zf/245/134a (70/10/20 wt %) | 391 | 0 |
| 1243zf/245/134a (50/20/30 wt %) | 637 | 0 |
| 1243zf/245/134a (20/30/50 wt %) | 1025 | 0 |
| 1243zf/245/134a (55/40/5 wt %) | 485 | 0 |
| 1234yf/245/32 (20/10/70 wt %) | 576 | 0 |
| 1234yf/245/32 (10/30/60 wt %) | 714 | 0 |
| 1234yf/245/32 (30/20/50 wt %) | 545 | 0 |
| 1234yf/245/32 (5/5/90 wt %) | 659 | 0 |
| 1234yf/245/32 (15/5/80 wt %) | 592 | 0 |
| 1234ze/245/32 (20/10/70 wt %) | 576 | 0 |
| 1234ze/245/32 (10/30/60 wt %) | 714 | 0 |
| 1234ze/245/32 (5/5/90 wt %) | 659 | 0 |
| 1234ze/245/32 (15/5/80 wt %) | 592 | 0 |
| 1243zf/245/32 (20/10/70 wt %) | 576 | 0 |
| 1243zf/245/32 (10/30/60 wt %) | 714 | 0 |
| 1243zf/245/32 (30/20/50 wt %) | 544 | 0 |
| 1243zf/245/32 (5/5/90 wt %) | 659 | 0 |
| 1243zf/245/32 (15/5/80 wt %) | 592 | 0 |

Table 4 shows that the compositions disclosed herein have GWP lower than the refrigerants currently in use.

### Example 3

### Cycle Performance

Table 5 shows the cooling performance of various refrigerant compositions as disclosed herein as compared to HCFC-22 and R407C. In the table, Evap Pres is evaporator pressure, Cond Pres is condenser pressure, Comp Exit T is compressor exit temperature, COP is coefficient of performance (analogous to energy efficiency), and Cap is cooling capacity. The data are based on the following conditions:

| Condenser Temperature | 54° C. (130° F.) |
|---|---|
| Evaporator Temperature | 7.2° C. (45° F.) |
| Subcool Temperature | 8.3° C. (15° F.) |
| Return Gas Temperature | 18° C. (65° F.) |
| Compressor Efficiency | 75% |

TABLE 5

| | | | | Cond/ | | |
|---|---|---|---|---|---|---|
| | | | Comp | Evap | | |
| | Evap | Cond | exit | average | | |
| Composition | pres, | pres, | temp, | temp | | Cap, |
| (wt %) | kPa | kPa | ° C. | glide, ° C. | COP | kW |
| R22 | 628 | 4331 | 99.6 | 0.00 | 3.43 | 6.15 |
| R407C | 636 | 4388 | 84.8 | 3.14 | 3.18 | 5.96 |
| R410A | 1,004 | 6922 | 85.5 | 0.08 | 3.04 | 8.03 |
| 1234yf/245cb/32 | | | | | | |
| 20/10/70 | 951 | 6560 | 85.9 | 2.97 | 3.24 | 8.20 |
| 10/30/60 | 833 | 5743 | 83.1 | 6.22 | 3.32 | 7.48 |
| 30/20/50 | 818 | 5638 | 80.6 | 7.33 | 3.38 | 7.27 |
| 5/5/90 | 1,011 | 6974 | 91.6 | 0.19 | 3.13 | 8.77 |
| 15/5/80 | 999 | 6888 | 89.1 | 0.89 | 3.15 | 8.53 |
| trans-1234ze/245cb/ | | | | | | |
| 32 | | | | | | |
| 20/10/70 | 865 | 5966 | 87.9 | 3.75 | 3.26 | 7.83 |
| 10/30/60 | 818 | 5638 | 82.7 | 5.97 | 3.38 | 7.46 |
| 5/5/90 | 971 | 6693 | 93.1 | 0.72 | 3.09 | 8.50 |
| 15/5/80 | 921 | 6351 | 91.1 | 1.78 | 3.16 | 8.19 |
| 1243zf/245cb/32 | | | | | | |
| 20/10/70 | 839 | 5785 | 88.8 | 3.81 | 3.26 | 7.67 |
| 10/30/60 | 806 | 5557 | 84.4 | 4.86 | 3.28 | 7.29 |
| 30/20/50 | 714 | 4925 | 82.8 | 6.06 | 3.45 | 6.75 |
| 5/5/90 | 958 | 6608 | 93.5 | 0.58 | 3.07 | 8.41 |
| 15/5/80 | 898 | 6194 | 91.9 | 1.94 | 3.15 | 8.06 |

Compositions of the present invention exhibit cooling performance very similar or improved versus current refrigerants, in particular, R-410A. For example, a mixture of 20/10/70 wt % 1234yf/245cb/32 has a higher COP and capacity than R-410A. And a mixture of 30/20/50 wt % 1243zf/245cb/32 has higher capacity and COP than R-22 and R-407C.

### Example 4

### Cycle Performance

Table 6 shows the cooling performance of various refrigerant compositions as disclosed herein as compared to HFC-134a, HCFC-124 and HFC-245cb alone. In the table, Evap Pres is evaporator pressure, Cond Pres is condenser pressure, Comp Exit T is compressor exit temperature, COP is coefficient of performance (analogous to energy efficiency), and Cap is cooling capacity. The data are based on the following conditions:

| Condenser Temperature | 54° C. (130° F.) |
|---|---|
| Evaporator Temperature | −12.2° C. (10° F.) |
| Subcool Temperature | 8.3° C. (15° F.) |
| Return Gas Temperature | 4.4° C. (40° F.) |
| Compressor Efficiency | 75% |

TABLE 6

| | | | | Cond/ | | |
|---|---|---|---|---|---|---|
| | | | Comp | Evap | | |
| | Evap | Cond | exit | average | | |
| Composition | pres, | pres, | temp, | temp | | Cap, |
| (wt %) | kPa | kPa | ° C. | glide, ° C. | COP | kW |
| R134a | 183 | 1475 | 90.4 | 0 | 1.99 | 1.75 |
| R124 | 98.6 | 836 | 86.7 | 0 | 2.10 | 1.03 |
| R245cb | 124 | 946 | 64.5 | 0 | 1.83 | 1.02 |
| 1234yf/245cb | | | | | | |
| 95/5 | 194 | 1304 | 76.8 | 0.06 | 1.88 | 1.56 |
| 80/20 | 188 | 1272 | 74.7 | 0.19 | 1.87 | 1.50 |
| 50/50 | 168 | 1182 | 70.8 | 0.75 | 1.85 | 1.35 |
| 20/80 | 143 | 1054 | 67.1 | 1.03 | 1.84 | 1.17 |
| trans-1234ze/245cb | | | | | | |
| 95/5 | 140 | 1098 | 83.1 | 1.03 | 2.00 | 1.32 |
| 80/20 | 159 | 1198 | 79.4 | 1.89 | 1.94 | 1.41 |
| 50/50 | 183 | 1289 | 72.3 | 0.00 | 1.81 | 1.43 |
| 20/80 | 157 | 1158 | 62.2 | 2.58 | 1.87 | 1.29 |
| 1243zf/245cb | | | | | | |
| 95/5 | 153 | 1135 | 86.6 | 0.58 | 2.05 | 1.45 |
| 80/20 | 168 | 1210 | 82.6 | 1.03 | 1.99 | 1.50 |
| 50/50 | 184 | 1278 | 74.7 | 0.00 | 1.87 | 1.49 |
| 20/80 | 159 | 1154 | 68.8 | 2.14 | 1.84 | 1.29 |
| 1234yf/245cb/134a | | | | | | |
| 90/5/5 | 194 | 1304 | 76.8 | 0.06 | 1.88 | 1.56 |
| 70/10/20 | 201 | 1378 | 78.2 | 0.39 | 1.89 | 1.64 |
| 50/20/30 | 193 | 1373 | 78.3 | 0.64 | 1.89 | 1.61 |
| 20/30/50 | 175 | 1362 | 80.8 | 1.08 | 1.87 | 1.52 |
| 55/40/5 | 177 | 1233 | 72.7 | 0.72 | 1.86 | 1.42 |
| trans-1234ze/245cb/ | | | | | | |
| 134a | | | | | | |
| 90/5/5 | 143 | 1125 | 83.4 | 1.08 | 2.00 | 1.35 |
| 70/10/20 | 159 | 1229 | 82.9 | 1.14 | 1.97 | 1.46 |
| 50/20/30 | 173 | 1307 | 81.1 | 0.36 | 1.92 | 1.52 |
| 20/30/50 | 174 | 1335 | 80.4 | 0.28 | 1.93 | 1.55 |
| 55/40/5 | 179 | 1289 | 74.9 | 0.25 | 1.84 | 1.45 |
| 1243zf/245cb/134a | | | | | | |
| 90/5/5 | 157 | 1165 | 86.7 | 0.67 | 2.04 | 1.48 |
| 70/10/20 | 171 | 1260 | 85.3 | 0.78 | 2.00 | 1.57 |
| 50/20/30 | 182 | 1327 | 82.8 | 0.22 | 1.96 | 1.61 |
| 20/30/50 | 179 | 1349 | 81.3 | 0.44 | 1.94 | 1.59 |
| 55/40/5 | 183 | 1285 | 77.3 | 0.08 | 1.90 | 1.52 |

Compositions of the present invention exhibit cooling performance, both COP and capacity similar to incumbent refrigerant R-134a. Compositions such as 20/80 wt % 1234yf/245cb are also a good match for HCFC-124.

1. A composition comprising: (a) 1,1,1,2,2-pentafluoropropane; (b) a compound selected from the group consisting of 2,3,3,3-tetrafluoropropene, E-1,3,3,3-tetrafluoropropene, and 1,1,1-trifluoropropene; and (c) a compound selected from the group consisting of 1,1,1,2-tetrafluoroethane and difluoromethane; wherein component (a), component (b) and component (c) are present in the composition as an azeotropic or azeotrope-like combination comprising component (a), component (b) and component (c).

2. (canceled)

3. (canceled)

4. (canceled)

5. (canceled)

6. The composition of claim 1 wherein component (c) is difluoromethane.

7. The composition of claim 6 comprising from about 0.1 wt % to about 30 wt % 1,1,1,2,2-pentafluoropropane, from about 1.0 wt % to about 49 wt % 2,3,3,3-tetrafluoropropene, and from about 50 wt % to about 98 wt % difluoromethane.

8. The composition of claim 6 comprising from about 0.1 wt % to about 30 wt % 1,1,1,2,2-pentafluoropropane, from about 1.0 wt % to about 40 wt % E-1,3,3,3-tetrafluoropropene, and from about 58 wt % to about 98 wt % difluoromethane.

9. The composition of claim 6 comprising from about 1.0 wt % to about 36 wt % 1,1,1,2,2-pentafluoropropane, from about 1.0 wt % to about 36 wt % 1,1,1-trifluoropropene, and from about 46 wt % to about 98 wt % difluoromethane.

10. The composition of claim 1 comprising an azeotropic combination of about 44.2 wt % 1,1,1,2,2-pentafluoropropane and about 55.8 wt % 1,3,3,3-tetrafluoropropene having a pressure of about 88.2 psia (608 kPa) at about 25° C.; or about 46.0 wt % 1,1,1,2,2-pentafluoropropane and about 54.0 wt % 3,3,3-trifluoropropene having a pressure of about 88.4 psia (609 kPa) at about 25° C.

11. The composition of claim 1 further comprising at least one lubricant selected from the group consisting of mineral oils, alkylbenzenes, polyalphaolefins, polyalkylene glycols, polyol esters, polyvinyl ethers, and mixtures thereof.

12. The compositions of claim 1 further comprising at least one additive selected from the group consisting of acetates, borates, carbonates, bicarbonates, phosphates, nitrates, hydroxides, oxides, molybdates, bromides, bromates, chlorates, chlorides, or iodides, phosphate esters, organic phosphonates, and phosphonium salts, boric acid, organic boron compounds, brominated compounds, chlorinated paraffins, ammonium polyphosphates, melamines, mixtures of water with polyalkylene glycols or polyol esters, perfluorinated lubricants, fluoroketones, fluoroiodo compounds, or mixtures thereof.

13. A process to produce cooling comprising condensing a composition of claim 1 and thereafter evaporating said composition in the vicinity of a body to be cooled.

14. A process to produce heat comprising condensing the composition of claim 1 in the vicinity of a body to be heated and thereafter evaporating said composition.

15. A foam blowing agent comprising the composition of claim 1.

16. A method of forming a foam comprising:
(a) adding to a foamable composition the composition of claim 1; and
(b) reacting the foamable composition under conditions effective to form a foam.

17. A sprayable composition comprising the composition of claim 1.

18. A process for producing aerosol products comprising the step of adding the composition of claim 1 to active ingredients in an aerosol container, wherein said composition functions as a propellant.

19. A process for recovering heat comprising evaporating a liquid phase working fluid comprising a composition of claim 1 in a heat exchanger in contact with a system that provides heat thus producing a vapor phase working fluid and passing said vapor phase working fluid to an expander wherein mechanical energy is produced.

20. (canceled)

21. (canceled)

22. A method for replacing a first refrigerant selected from the group consisting of R134a, R22, R12, R124, R404A, R410A, R407C, R413A, R417A, R422A, R422B, R422C and R422D, R423A, R424A, R426A, R428A, R430A, R434A, R437A, R438A, R507A, and R502 in a system that uses, used or was designed to use said first refrigerant said method comprising providing a composition of claim 1 to said system.

23. The method of claim 22, wherein said first refrigerant is R22, R407C, or R410A and wherein the composition provided to the system comprises HFC-245cb, HFC-32 and one of HFO-1234yf, trans-HFO-1234ze or HFO-1243zf.

24. The method of claim 22, wherein said first refrigerant is R134a or R124 and wherein the composition provided to the system comprises HFC-245cb, one of HFO-1234yf, trans-HFO-1234ze or HFO-1243zf, and optionally HFC-134a.

25. A refrigeration, air conditioning or heat pump apparatus comprising a compressor, a condenser, an expansion device and an evaporator, wherein the apparatus contains the composition of claim 1.
